(19) United States
(12) Patent Application Publication
(10) Pub. No.: US 2012/0287651 A1
(43) Pub. Date: Nov. 15, 2012

(54) ILLUMINATION APPARATUS AND FAN UNIT FOR ILLUMINATION APPARATUS

(75) Inventor: Masahiko HIRATA, Otta (JP)

(73) Assignee: PANASONIC CORPORATION, Osaka (JP)

(21) Appl. No.: 13/465,588

(22) Filed: May 7, 2012

(30) Foreign Application Priority Data
May 9, 2011 (JP) 2011-104663
Jul. 8, 2011 (JP) 2011-151571
Jul. 11, 2011 (JP) 2011-152523
Oct. 28, 2011 (JP) 2011-236902
Nov. 2, 2011 (JP) 2011-240944

(51) Int. Cl. F21V 29/00

(52) U.S. Cl. 362/373

(57) ABSTRACT

An illumination apparatus that can always take in cool air and use it for cooling and improve a heat dissipation effect of a fan. LED lamp (illumination apparatus) 100 is provided with case 110, LED 121, heat sink 130 and fan apparatus 140 that blows air over heat sink 130. Heat sink 130 is mounted with fan apparatus 140 at a decentered position, and is provided with intake ports 131 that take air into fan apparatus 140, and exhaust ports 132 that exhaust the air blown over heat sink 130 on the same plane.

### CROSS REFERENCE TO RELATED APPLICATIONS

The disclosure of Japanese Patent Applications No. 2011-104663 filed on May 9, 2011, No. 2011-151571 filed on Jul. 8, 2011, No. 2011-152523 filed on Jul. 11, 2011, No. 2011-236902 filed on Oct. 28, 2011 and No. 2011-240944 filed on Nov. 2, 2011 including the specification, drawings and abstract is incorporated herein by reference in its entirety.

### TECHNICAL FIELD

The present invention relates to an illumination apparatus provided with a fan apparatus and a fan unit for the illumination apparatus.

### BACKGROUND ART

In recent years, various LED (Light Emitting Diode) bulbs are being developed as illumination apparatuses that substitute for incandescent electric lamps. Since a plurality of LEDs are used for these LED bulbs, a large amount of heat is produced. Therefore, there is a strong demand for efficient dissipation of heat generated in the LEDs.

(JP2007-265892A) describes an LED bulb that incorporates a cooling fan to forcibly dissipate heat to thereby improve heat dissipation efficiency.

However, the LED bulb in (JP2007-265892A) needs spaces for housing a lighting circuit, fan motor and drive circuit for the motor when the air-cooling fan is mounted inside, and is therefore not fitted for miniaturization.

(JP2010-108774A) describes a bulb-type lamp that uses an LED as a light-emitting body and can support the miniaturization while securing the cooling efficiency. The bulb-type lamp described in (JP2010-108774A) is provided with a substrate, one principal surface of which is provided with a light-emitting device, a radiator, one end side of which has close contact with the other principal surface of the substrate and which incorporates a housing section, an air-cooling section housed in the housing section of the radiator, a globe that covers the substrate and is attached to one end side of the radiator, a base provided on the other end side of the radiator, a lighting circuit that is housed between the radiator and the base to turn on the light-emitting device and a drive circuit provided on the substrate to drive the air-cooling section.

FIG. 1 is an outside view of a bulb-type lamp described in (JP2010-108774A).

As shown in FIG. 1, bulb-type lamp 10 is provided with substantially spherical globe 11 made of glass and having light diffusing ability, body case 12 and base 13.

Body case 12 includes intake ports 14 formed on the entire circumference and exhaust ports 15 formed above intake ports 14 on the entire circumference. Body case 12 accommodates a radiator that dissipates heat of the LED substrate section and an air-cooling section that cools the radiator using a fan (all of which are not shown).

Intake ports 14 take outside air into body case 12 through an air-cooling section (not shown). Intake ports 14 are formed in an elongated hole shape along the axial direction of body case 12 and spaced substantially uniformly in the circumferential direction of body case 12.

Exhaust ports 15 exhaust the air taken into body case 12 to the outside. Exhaust ports 15 are formed spaced substantially uniformly in the circumferential direction of body case 12.

As shown in FIG. 1, bulb-type lamp 10 is provided with intake ports 14 and exhaust ports 15 lined up and down in an annular shape around body case 12.

In the above-described configuration, bulb-type lamp 10 takes in outside air from intake ports 14 in the lower part of body case 12 in a substantially right-left direction, turns the air direction upward inside body case 12 and then exhausts the air from exhaust ports 15 in the upper part of body case 12 in a substantially right-left direction. For this reason, in bulb-type lamp 10, intake ports 14 and exhaust ports 15 are located close to each other although their intake and exhaust positions are different in the height direction.

### SUMMARY OF INVENTION

### Technical Problem

However, since intake ports 14 and exhaust ports 15 are located close to each other, the bulb-type lamp described in (JP2010-108774A) has a disadvantage that the warm air exhausted from exhaust ports 15 is taken in through intake ports 14. This results in a problem that the heat dissipation effect of the fan decreases.

It is therefore an object of the present invention to provide an illumination apparatus and a fan unit for the illumination apparatus that arranges intake ports and exhaust ports spaced apart from each other to separate intake from exhaust air, and can thereby always take in cool air and use it for cooling and improve the heat dissipation effect of the fan.

### Solution to Problem

An illumination apparatus according to the present invention includes: an LED; a heat sink that dissipates heat of the LED; a case having an opening on the heat sink side; intake ports formed in the heat sink or in some parts on an outer circumference side of the case, exhaust ports that exhaust air blown over the heat sink, the exhaust ports being formed in some other parts on the outer circumference side of the heat sink or the case where the intake ports are not formed; a fan apparatus that blows the air taken in via the intake port to the heat sink side, the fan apparatus being provided between the heat sink and the case; and a partition plate that separates a first space including the intake ports from a second space including the exhaust ports.

A fan unit for an illumination apparatus according to the present invention includes: a heat sink that dissipates heat of an LED; intake ports formed at some parts on the outer circumference side of the heat sink; exhaust ports that exhaust air blown over the heat sink, the exhaust ports being formed at some other parts on the outer circumference side of the heat sink where the intake ports are not formed; a fan apparatus that blows the air taken in via the intake ports to the heat sink side, the fan apparatus being provided on the heat sink, and a partition plate that separates a first space including the intake ports from a second space including the exhaust ports.

### Advantageous Effects of Invention

According to the present invention, it is possible to separate intake air from exhaust air in a right-left direction, and thereby always take in cool air and use it for cooling and improve the heat dissipation effect of the fan.

### BRIEF DESCRIPTION OF DRAWINGS

FIG. 1 is an outside view of a conventional bulb-type lamp;

FIG. 2 is an outside view of an illumination apparatus according to Embodiment 1 of the present invention;

FIG. 3 is a perspective view of the illumination apparatus according to Embodiment 1 above;

FIG. 4 is an exploded perspective view of the illumination apparatus according to Embodiment 1 above;

FIG. 5 is an exploded perspective view of the illumination apparatus according to Embodiment 1 above;

FIG. 6 is a top view illustrating a detailed configuration of a heat sink of the illumination apparatus according to Embodiment 1 above;

FIG. 7 is a perspective view illustrating a detailed configuration of the heat sink of the illumination apparatus according to Embodiment 1 above;

FIG. 8 is a perspective view illustrating a detailed configuration of the heat sink of the illumination apparatus according to Embodiment 1 above;

FIG. 9 is a bottom view illustrating a detailed configuration of the heat sink of the illumination apparatus according to Embodiment 1 above;

FIG. 10 is a cross-sectional view of the heat sink mounted with a fan apparatus of the illumination apparatus according to Embodiment 1 above;

FIG. 11 is a cross-sectional view illustrating an air flow of the illumination apparatus according to Embodiment 1 above;

FIG. 12 is a perspective view illustrating an air flow of the illumination apparatus according to Embodiment 1 above;

FIG. 13 is a top view illustrating a configuration of another partition type of the fan apparatus of the illumination apparatus according to Embodiment 1 above;

FIG. 14 is a perspective view illustrating a configuration of a further partition type of the fan apparatus of the illumination apparatus according to Embodiment 1 above;

FIG. 15 is a top view of an illumination apparatus according to Embodiment 2 of the present invention;

FIG. 16 is a cross-sectional view of the illumination apparatus according to Embodiment 2 above;

FIG. 17 is a cross-sectional view illustrating a detailed configuration of the illumination apparatus according to Embodiment 2 above;

FIG. 18 is a perspective view illustrating a detailed configuration of the illumination apparatus according to Embodiment 2 above;

FIG. 19 is a top view illustrating a detailed configuration of a heat sink of the illumination apparatus according to Embodiment 2 above;

FIG. 20 is a perspective view illustrating a detailed configuration of the heat sink of the illumination apparatus according to Embodiment 2 above;

FIG. 21 is a perspective view illustrating a detailed configuration of the heat sink of the illumination apparatus according to Embodiment 2 above;

FIG. 22 is a perspective view of the heat sink with the plate cover in FIG. 21 removed;

FIG. 23 is a cross-sectional view illustrating an air flow of the illumination apparatus according to Embodiment 2 above;

FIG. 24 is a perspective view illustrating a detailed configuration of a heat sink of an illumination apparatus according to Embodiment 3 of the present invention;

FIG. 25 is a perspective view illustrating a detailed configuration of the heat sink of the illumination apparatus according to Embodiment 3 above;

FIG. 26 is a cross-sectional view of a fan apparatus of the illumination apparatus according to Embodiment 3 above;

FIG. 27 is a configuration diagram of a fan blade of the fan apparatus of the illumination apparatus according to Embodiment 3 above;

FIG. 28 is a cross-sectional view of a fan apparatus of an illumination apparatus according to Embodiment 4 of the present invention;

FIG. 29 is a configuration diagram of a fan blade of the fan apparatus of the illumination apparatus according to Embodiment 4 above;

FIG. 30 is a perspective view illustrating a detailed configuration of a heat sink of an illumination apparatus according to Embodiment 5 of the present invention;

FIG. 31 is a bottom view illustrating a detailed configuration of the heat sink of the illumination apparatus according to Embodiment 5 above;

FIG. 32 is a perspective view of an illumination apparatus according to Embodiment 6 of the present invention;

FIG. 33 is a perspective view of the illumination apparatus according to Embodiment 6 above;

FIG. 34 is a perspective view illustrating an air flow of the illumination apparatus according to Embodiment 6 above; and

FIG. 35 is a cross-sectional view illustrating an air flow of the illumination apparatus according to Embodiment 6 above.

### DESCRIPTION OF EMBODIMENTS

Hereinafter, embodiments of the present invention will be described in detail with reference to the accompanying drawings.

### Embodiment 1

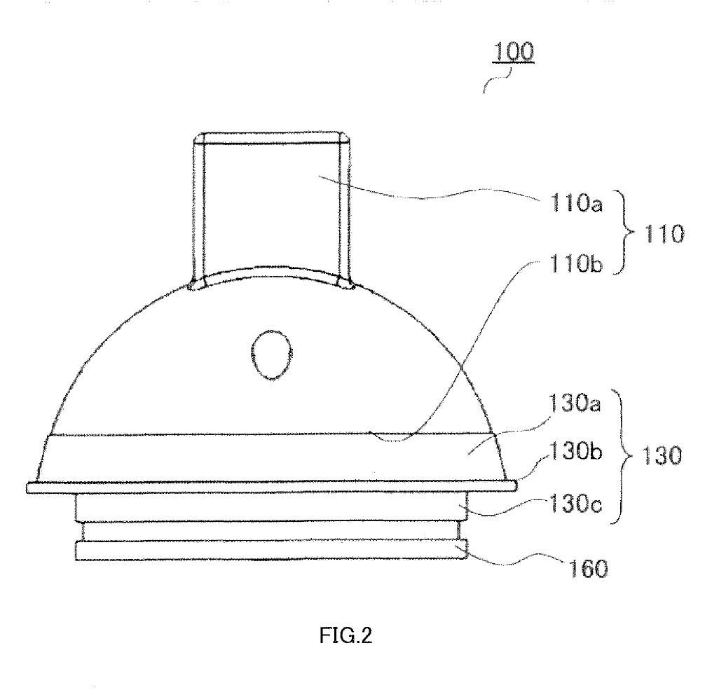

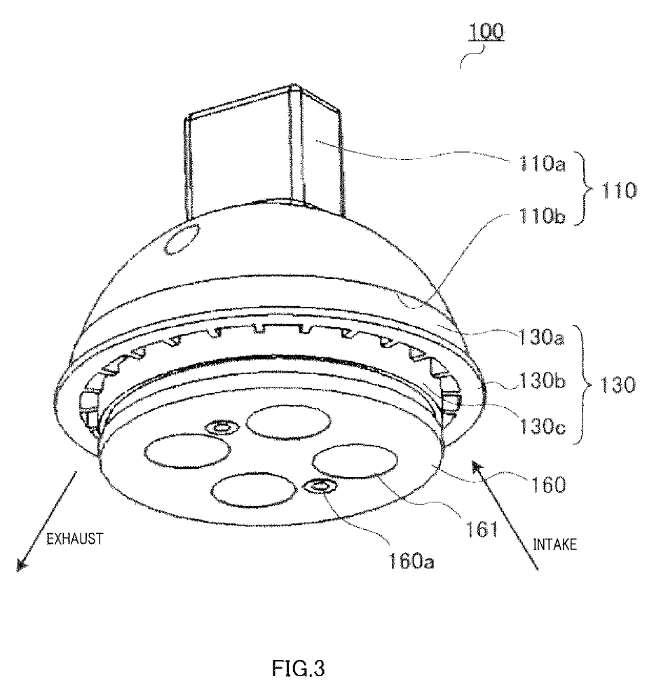

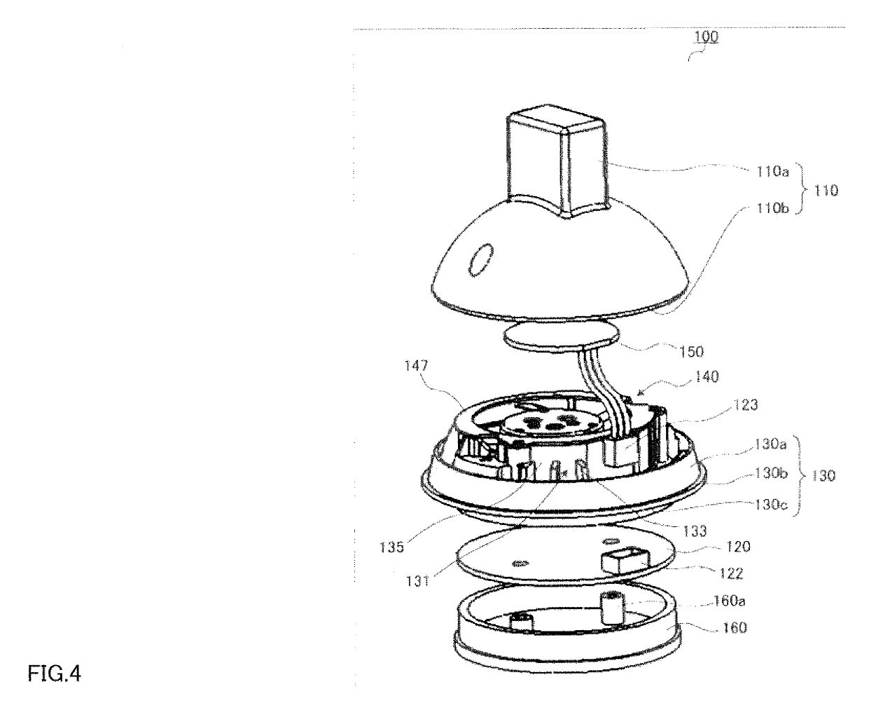

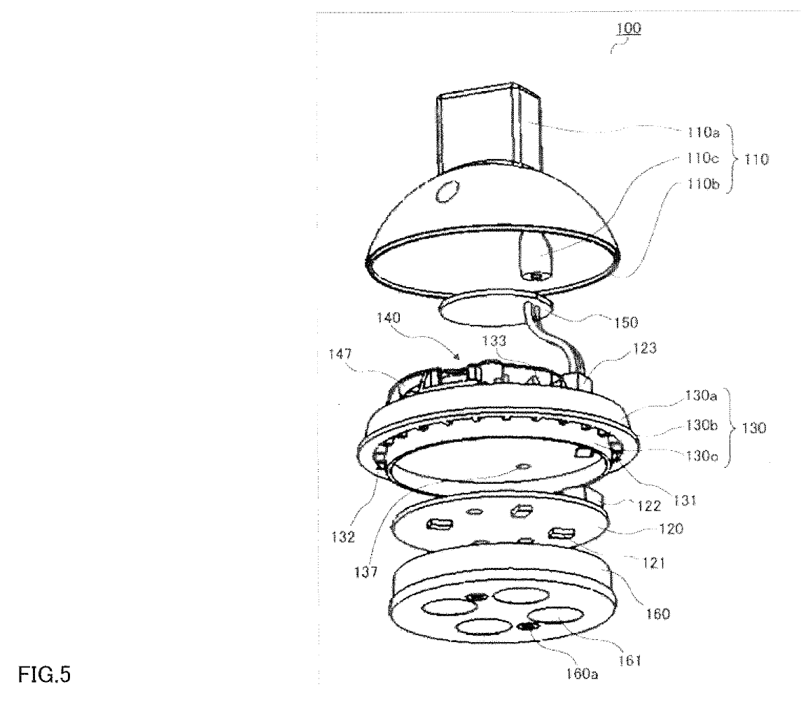

FIG. 2 and FIG. 3 are outside views of an illumination apparatus according to Embodiment 1 of the present invention. FIG. 2 is a front view and FIG. 3 is a perspective view viewed from below. FIG. 4 and FIG. 5 are exploded perspective views of the illumination apparatus above. FIG. 4 is a diagram viewed from above and FIG. 5 is a diagram viewed from below.

The present embodiment is an example where the present invention is applied to an undersurface intake/exhaust LED lamp in which the intake/exhaust direction is on the undersurface side.

As shown in FIG. 2 to FIG. 5, LED lamp 100 is provided with case 110 including base 110a and opening 110b, LED substrate 120 mounted with LEDs 121, heat sink 130 that cools the heat of LEDs 121 and fan apparatus 140 that blows air over heat sink 130.

Furthermore, LED lamp 100 is provided with power supply substrate 150 that supplies power to LED substrate 120 and fan apparatus 140, connector 123 that connects the power of power supply substrate 150 to connector plug 122 of LED substrate 120 and irradiation section 160 that is attached below heat sink 130 and has lenses 161 to spread light from LEDs 121.

LED substrate 120, heat sink 130, fan apparatus 140, power supply substrate 150, and irradiation section 160 described above are tightened together to screw retainer 110c of an inner wall of case 110 with screws (FIG. 5) via threaded holes 160a formed in irradiation section 160.

Case 110 is made of a member having a good heat dissipation characteristic such as aluminum alloy. Case 110 is formed in a hemispheric shape with its diameter gradually increasing from rectangular parallelepiped base 110a on one end side toward opening 110b on the other end side.

LED substrate 120 is mounted with LEDs 121 and provided in contact with heat sink 130. LED substrate 120 is a metal base substrate formed of a metallic material having a good heat dissipation characteristic such as aluminum or insulating material. LED substrate 120 is heat-dissipated in contact with heat sink 130.

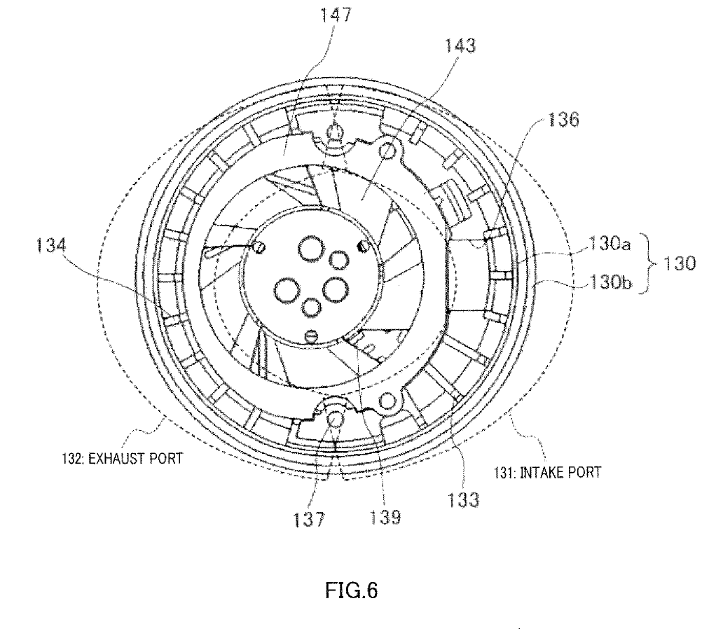

Heat sink 130 is attached to opening 110b of case 110 in the same diameter as that of outer circumferential part 130a and cools LEDs 121 in contact with LED substrate 120. In addition to the basic function of cooling the heat of LEDs 121 in contact with LED substrate 120, heat sink 130 is mounted with fan apparatus 140 at a position deviated from the center of heat sink 130 (decentered position) and includes intake ports 131 that take air into fan apparatus 140, fan apparatus 140 and exhaust ports 132 arranged on substantially the same plane along heat sink 130. Details of heat sink 130 will be described later using FIG. 6 to FIG. 9.

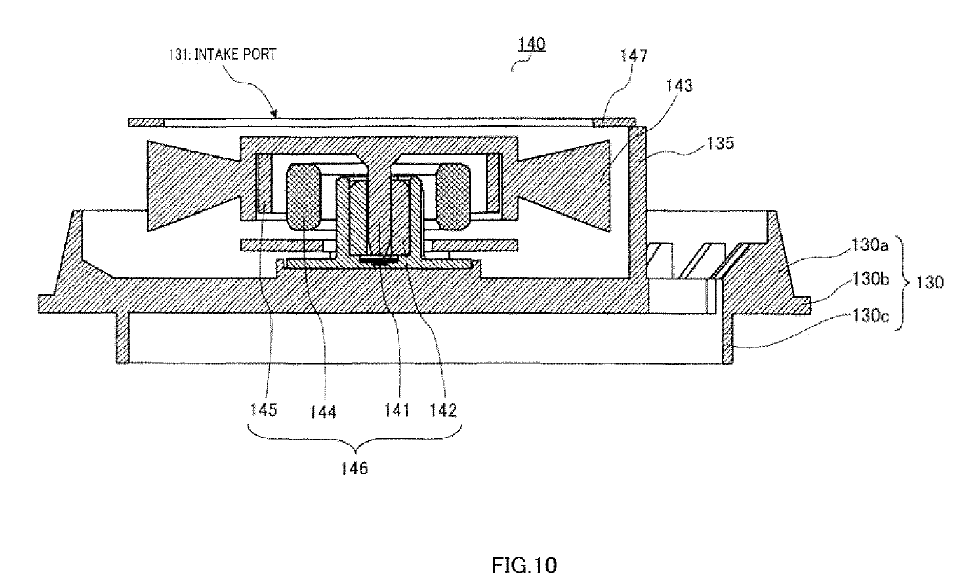

Fan apparatus 140 generates an air flow via heat sink 130 to cool heat sink 130. Fan apparatus 140 is mounted on heat sink 130 in case 110 and blows air over heat sink 130. To be more specific, fan apparatus 140 has an air exhaust surface provided opposite to heat sink 130 and an air intake surface provided opposite to the air exhaust surface and blows the air taken in via intake port 131 from the air exhaust surface over heat sink 130. Details of fan apparatus 140 will be described later using FIG. 10.

Power supply substrate 150 supplies DC power to LED substrate 120 and fan apparatus 140 via connector 123.

Irradiation section 160 is attached below heat sink 130 in substantially the same diameter as that of outer circumferential part 130a of heat sink 130. Irradiation section 160 has flat spherical lenses 161 made of glass or synthetic resin or the like having a light diffusing ability. Lens 161 covers a light-emitting surface of LED 121 to spread light from LED 121.

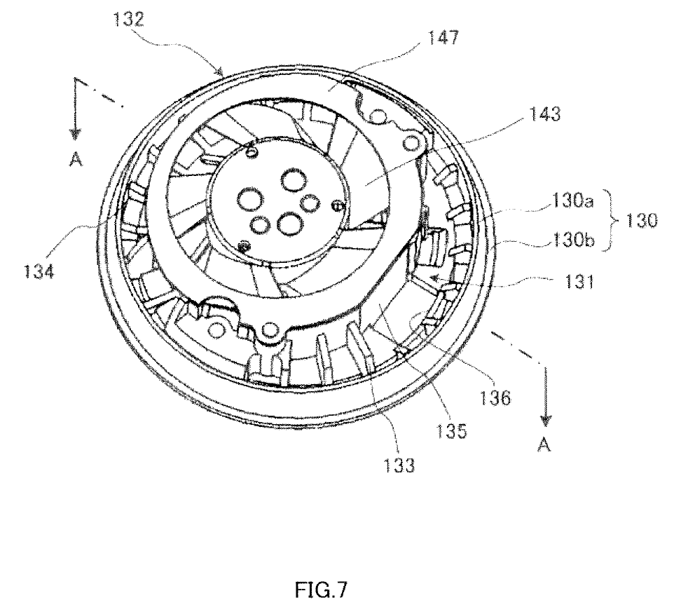

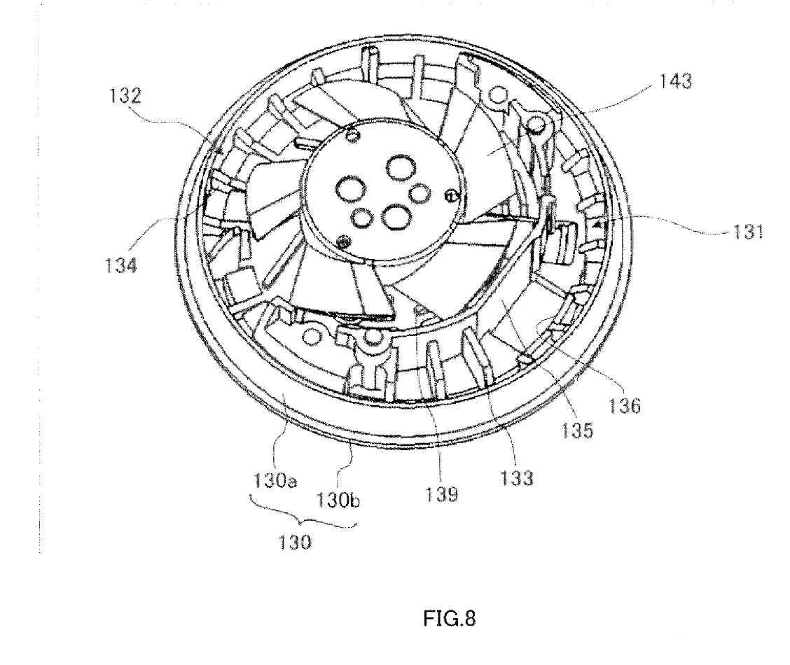

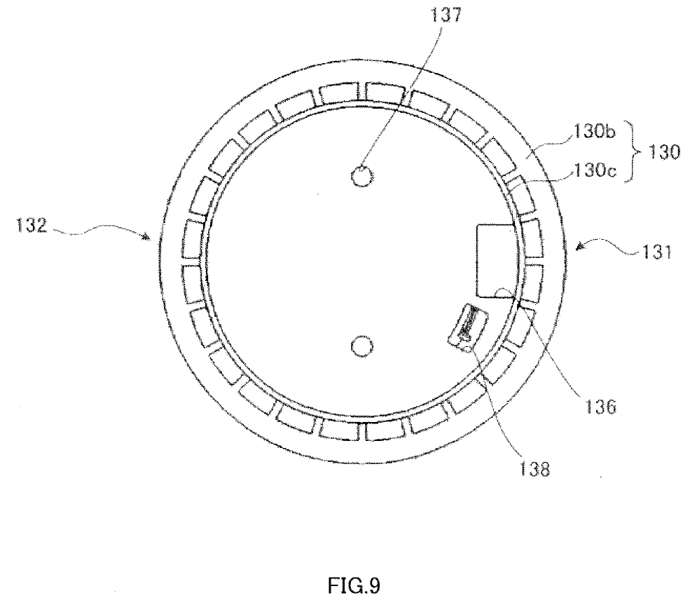

FIG. 6 to FIG. 9 are diagrams illustrating a detailed configuration of heat sink 130. FIG. 6 is a top view thereof, FIG. 7 is a perspective view thereof, FIG. 8 is a perspective view of heat sink 130 in FIG. 7 with the plate cover removed and FIG. 9 is a bottom view thereof.

As shown in FIG. 6 to FIG. 9, heat sink 130 includes outer circumferential part 130a having the same diameter as that of opening 110b of case 110, flange section 130b that protrudes outward from outer circumferential part 130a and cylindrical section 130c (FIG. 9) that accommodates circular LED substrate 120.

Heat sink 130 is mounted with fan apparatus 140 at a position deviated from the center of heat sink 130 (decentered position), and is provided with intake ports 131 that take air into fan apparatus 140 and exhaust ports 132 that exhaust the air blown over heat sink 130 on the same plane. Intake ports 131 and exhaust ports 132 are formed in the undersurface of heat sink 130.

Both heat sink 130 and fan apparatus 140 have circular shapes when seen from above and heat sink 130 has a greater diameter. Since fan apparatus 140 is mounted within the outer diameter of heat sink 130, a circular space is formed on the outer circumference of fan apparatus 140. Intake ports 131 are formed on one semi-circle side and exhaust ports 132 are formed on the other semi-circle side. Since intake ports 131 and exhaust ports 132 are formed on both sides of fan apparatus 140 mounted on heat sink 130, that is, on both semi-circle sides of heat sink 130, both ports are aligned on the same plane.

Furthermore, the present embodiment places fan apparatus 140 at a position deviated from the center of heat sink 130 (decentered position), assigns the semi-circle side with a wider space to intake ports 131 and assigns the semi-circle side with a narrower space to exhaust ports 132. Greater (here, higher) heat dissipation fins 133 are formed for heat sink 130 on the intake port 131 side and smaller (here, lower) heat dissipation fins 134 are formed for heat sink 130 on the exhaust port 132 side.

Heat sink 130 includes partition plate 135 between intake ports 131 and fan apparatus 140 to change the flow of intake air and causes the intake air to flow into fan apparatus 140. Partition plate 135 is a screen that covers the intake port 131 side of fan apparatus 140 in a substantially semi-circular shape along the shape of fan apparatus 140. Partition plate 135 separates a first space including intake ports 131 and the air intake surface of fan apparatus 140 from a second space including exhaust ports 132, the air exhaust surface of fan apparatus 140 and heat sink 130. The air taken in by fan apparatus 140 is blown over partition plate 135, and with the flow direction changed, flown into the intake port inside plate cover 147 above fan apparatus 140.

Plate cover 147 is attached above partition plate 135 so as to cover the top outer circumference of fan apparatus 140 and improve the air-blowing efficiency. Plate cover 147 serves as an intake port to fan apparatus 140 and regulates the air flow as well.

Hole 136 is formed in the undersurface of heat sink 130 below partition plate 135 on the intake port 131 side to allow connector 123 to pass. As shown in FIG. 9, threaded holes 137 and hole 138 for adjusting fan apparatus 140 after mounting fan apparatus 140 are formed in the undersurface of heat sink 130. Furthermore, air adjusting protrusions 139 are formed concentrically on the mounting surface of fan apparatus 140 on heat sink 130.

FIG. 10 is a cross-sectional view of heat sink 130 on which fan apparatus 140 is mounted. FIG. 10 is a cross-sectional view indicated by arrow A-A in FIG. 7.

As shown in FIG. 10, fan apparatus 140 is constructed of shaft 141, bearing 142, fan blade 143 attached to an end of shaft 141, stator 144 and annular magnet 145 attached inside fan blade 143, each of which is integrated into a single unit.

Shaft 141, bearing 142, stator 144, and annular magnet 145 described above as a whole constitute motor 146. Furthermore, plate cover 147 is attached above fan apparatus 140.

Shaft 141 is rotatably supported by bearing 142 to rotate fan blade 143. Fan blade 143 is driven to rotate by stator 144 and annular magnet 145.

Stator 144 is formed by stacking metal plates made of a magnetic material one on another in the axial direction of the axis of rotation. An insulating layer is formed at each teeth section of stator 144 through electro coating or the like and a coil is wound via this insulating layer. Passing a current through this coil produces a magnetic field causing the coil to attract or repulse magnet 145, whereby stator 144 is driven.

The structure of motor 146 is not limited to the above-described structure and any structure can be adopted as long as it can drive fan apparatus 140.

Hereinafter, operation of the illumination apparatus configured as shown above will be described.

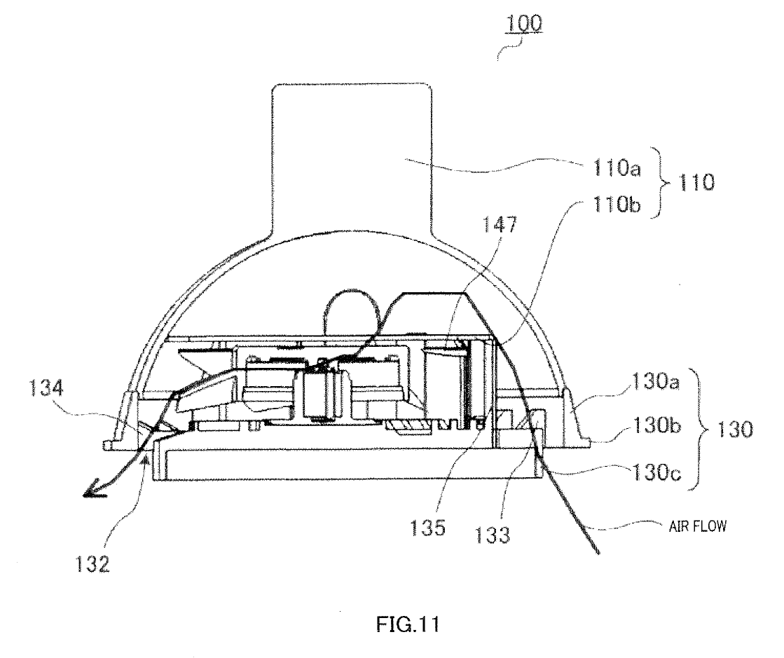

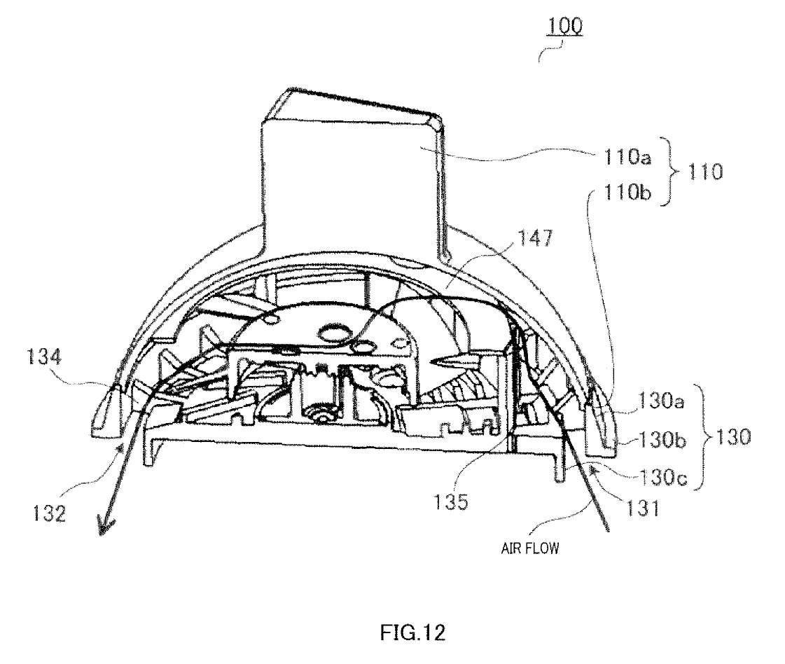

FIG. 11 and FIG. 12 illustrate an air flow of the illumination apparatus according to the present embodiment of the invention. FIG. 11 is a cross-sectional view thereof and FIG. 12 is a perspective view thereof. The motor 146 part is omitted for convenience of description. The solid line arrow in FIG. 11 and FIG. 12 indicates the air flow.

As shown in FIG. 11 and FIG. 12, heat sink 130 is provided with fan apparatus 140 at a position deviated from the center of heat sink 130 (decentered position), and is provided with intake ports 131 and exhaust ports 132 on the same plane. The semi-circle side with a wider space is assigned to intake ports 131 and the semi-circle side with a narrower space is assigned to exhaust ports 132.

With outer circumferential part 130a of heat sink 130 attached to opening 110b of case 110, intake ports 131 are arranged on the one semi-circle side of substantially circular case 110 and exhaust ports 132 are arranged on the other semi-circle side. That is, intake ports 131 and exhaust ports 132 are arranged on the same plane and on the different sides.

Furthermore, partition plate 135 is arranged in case 110, partition plate 135 which separates the intake port 131 side from exhaust port 132 side. In the present embodiment, partition plate 135 is formed between intake ports 131 and fan apparatus 140 on heat sink 130. Of the two regions partitioned by partition plate 135, the side on which fan blade 143 is arranged outward is the exhaust port 132 side. As the air intake/exhaust direction, there are undersurface air intake/exhaust and lateral air intake/exhaust, and the present embodiment shows an example of undersurface air intake/exhaust.

To improve the air-blowing efficiency of fan apparatus 140 here, the periphery of fan blade 143 needs to be surrounded to regulate the air direction. The arrangement of partition plate 135 and plate cover 147 improves the air-blowing efficiency.

As shown in FIG. 11 and FIG. 12, when fan apparatus 140 operates, the air is taken in from intake ports 131 of the undersurface of heat sink 130, blown over partition plate 135, flows along the side of partition plate 135 and reaches an area above fan apparatus 140. The air then goes beyond plate cover 147, is sucked into fan apparatus 140 and exhausted from exhaust ports 132 of the undersurface of heat sink 130.

Thus, the present embodiment separates intake air from exhaust air in the right-left direction (not in the up-down direction), and can thereby always take in cool air and use it for cooling. That is, the prior arts divide air intake/exhaust in the up-down direction, resulting in a disadvantage that the intake ports and exhaust ports are located close to each other, resulting in a disadvantage that the heat dissipation effect of the fan deteriorates. On the other hand, as shown in FIG. 11 and FIG. 12, in the present embodiment, intake ports 131 and exhaust ports 132 are arranged at the positions structurally most distant from each other, namely both the right and left end positions on the undersurface of opening 110b of case 110, and it is thereby possible to always take in cool air and use it for cooling and significantly improve the heat dissipation effect of the fan.

Furthermore, there are also the following differences between the present embodiment and prior arts in the shapes of areas formed in the intake and exhaust ports.

In the prior arts, the fan has a small width in the axial direction and has an annular shape (elongated in a plan view) and the resistance of the passing air is strong. By contrast, intake ports 131 and exhaust ports 132 are semi-circular in the present embodiment, and more similar to a square in a plan view than in the prior arts. For this reason, the resistance of the passing air becomes smaller and the air-blowing efficiency can be improved.

Furthermore, in the prior arts, when an attempt is made to increase the distance between the intake ports and the exhaust ports, it is necessary to reduce the sizes of openings of the intake ports and exhaust ports so as to keep those ports relatively distant from each other. The present embodiment has no such structural constraints and can increase the sizes of openings of intake ports 131 and exhaust ports 132 and significantly improve the air-blowing efficiency.

Furthermore, as shown in FIG. 11 and FIG. 12, the air in case 110 basically flows in the right-left direction and there are no forced directional changes. Since the air direction is changed moderately, there is less resistance to the air and the air-blowing efficiency can be improved.

In addition to the above features, the present embodiment further has the following features.

In the structure in which fan apparatus 140 is arranged on the top surface of heat sink 130 to dissipate the heat of LED substrate 120 on the undersurface of heat sink 130, there needs to be an area for arranging connector 123 and wiring for connecting LED substrate 120 and power supply substrate 150.

The present embodiment arranges fan apparatus 140 at a position deviated from the center of heat sink 130 so that the intake port 131 side is broader than the exhaust port 132 side. An area for connector 123 and wiring is secured on this widely formed intake port 131 side. To be more specific, hole 136 for allowing connector 123 to pass through is opened in the undersurface below partition plate 135 on the intake port 131 side. Since the air flow rate is greater on the exhaust port 132 side than the intake port 131 side, when hole 136 is formed on the exhaust port 132 side, air is more likely to leak out. The present embodiment forms the intake port 131 side wider than the exhaust port 132 side and forms hole 136 to thereby prevent air leakage, and also arranges connector 123 and wiring on the intake port 131 side where the air flow rate is moderate so as not to obstruct the air flow as much as possible.

Furthermore, in the present embodiment, since exhaust port 132 and fan blade 143 are placed so as to overlap with each other, the promoted air is linearly exhausted from exhaust port 132, it is thereby possible to improve the air intake/exhaust efficiency.

Furthermore, the present embodiment forms partition plate 135 in heat sink 130. Since partition plate 135 is part of heat sink 130, partition plate 135 has good thermal conductivity and can improve the heat dissipation effect.

Furthermore, the present embodiment forms partition plate 135 on the intake port 131 side. Since there is no object that blocks the air flow in the vicinity of exhaust port 132, it is possible to improve the air intake/exhaust efficiency. Furthermore, there is a high degree of freedom in the arrangement of fan apparatus 140.

Furthermore, the present embodiment forms larger (higher) fins 133 on the intake port 131 side than fins 134 on the exhaust port 132 side. This is attributable to the following reasons. Since the exhaust port 132 side has a higher air velocity than the intake port 131 side, the fins on the exhaust port 132 side are more likely to block the air flow and cause the air velocity to decrease. By contrast, intake ports 131 on the intake port 131 side as a whole take in air uniformly and the fins are less likely to block the air, and therefore the size of fins can be increased. Forming many and large fins can increase the heat dissipation effect of heat sink 130.

To prevent the air from flowing backward from the exhaust side to the intake side, partition plate 135 is preferably extended beyond the top end of fan apparatus 140. The sizes of exhaust ports 132 and intake ports 131 may be about the same. The greater the sizes of exhaust ports 132 and intake ports 131, the better.

It is not impossible to arrange fan apparatus 140 on the intake port 131 side, but there is the following demerit.

The air immediately after passing through fan apparatus 140 has a high velocity, and has therefore strong inertia having a tendency to move straightforwardly. Therefore, such air tends to move straightforwardly as is, and be exhausted. If fan apparatus 140 is placed on the intake port 131 side, the air blows over case 110 once and then has to change the direction thereof toward the exhaust port 132 side. This constitutes great resistance to the air.

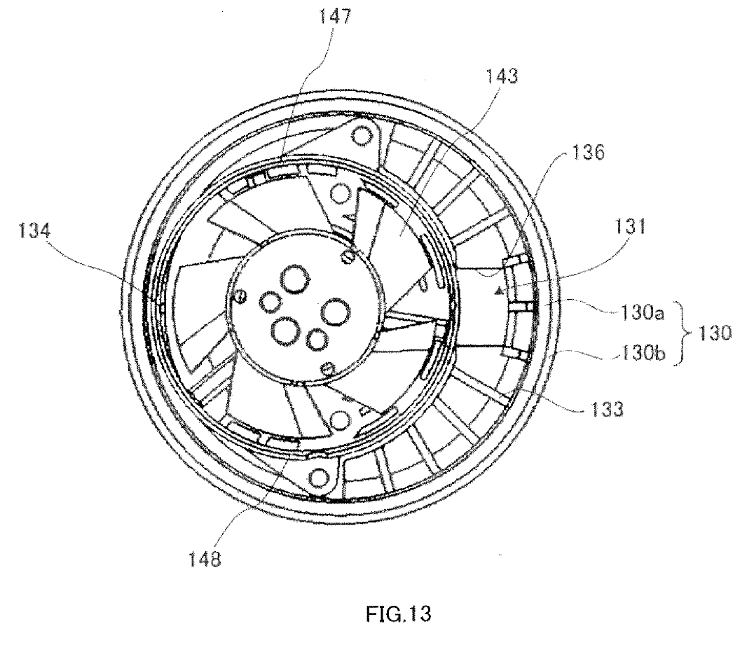

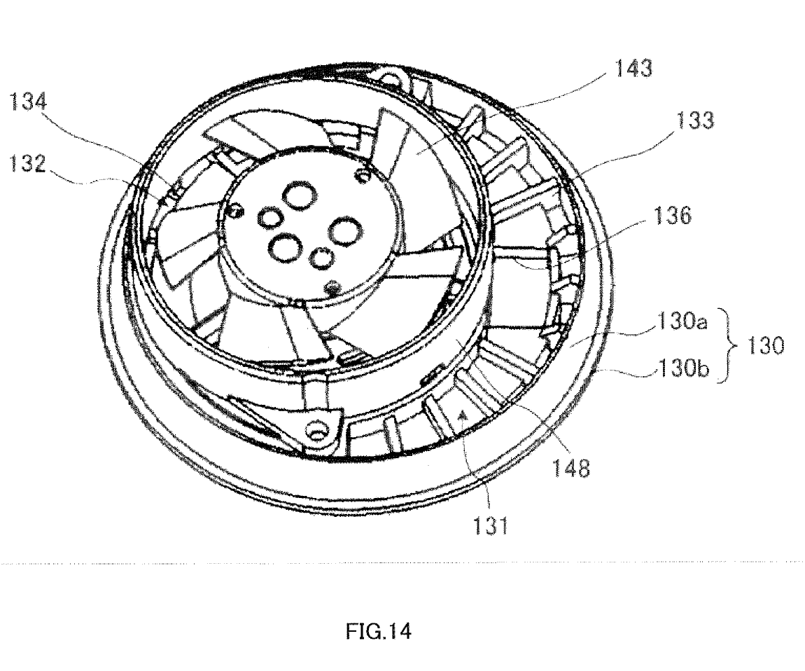

FIG. 13 and FIG. 14 are diagrams illustrating a configuration of another partition type of fan apparatus 140. FIG. 13 is a top view thereof and FIG. 14 is a perspective view thereof.

Examples of the partition type include a box fan type and a heat-sink-integrated type.

The heat-sink-integrated type in which partition plate 135 is formed in heat sink 130 has already been described.

As shown in FIG. 13 and FIG. 14, the box fan type is provided with annular partition plate 148 that surrounds the outer circumference of fan apparatus 140 instead of partition plate 135. Since annular partition plate 148 surrounds the entire circumference of fan apparatus 140, the box fan type has a high rectification effect and provides an effect of high air-blowing efficiency of the fan.

As has been described in detail so far, LED lamp 100 of the present embodiment is provided with case 110 having substantially circular opening 110b, LED substrate 120 mounted with LEDs 121, heat sink 130 that cools the heat of LEDs 121 and fan apparatus 140 that blows air over heat sink 130. Heat sink 130 is mounted with fan apparatus 140 at a position deviated from the center of heat sink 130 (decentered position), and is provided with intake ports 131 that take air into fan apparatus 140 and exhaust ports 132 that exhaust air blown over heat sink 130 on the same plane. That is, by arranging intake ports 131 on one semi-circle side and exhaust ports 132 on the other semi-circle side of substantially circular case 110, intake ports 131 and exhaust ports 132 are arranged on the same plane as well as on different sides of case 110.

In the above-described configuration, air is taken in from intake ports 131 in the undersurface of heat sink 130, blown over partition plate 135, moves along the side of partition plate 135 and reaches an area above fan apparatus 140. The air goes beyond plate cover 147, is sucked into fan apparatus 140 from above and exhausted from exhaust ports 132 in the undersurface of heat sink 130.

Thus, since intake air is separated from exhaust air in the right-left direction (not in the up-down direction), it is possible to always take in cool air and use it for cooling, and thereby significantly improve the heat dissipation effect of the fan.

### Embodiment 2

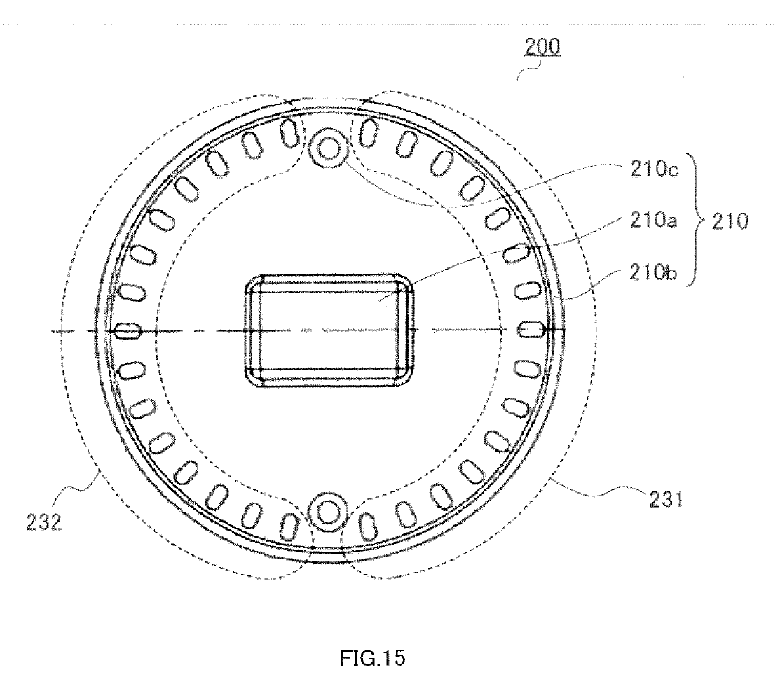

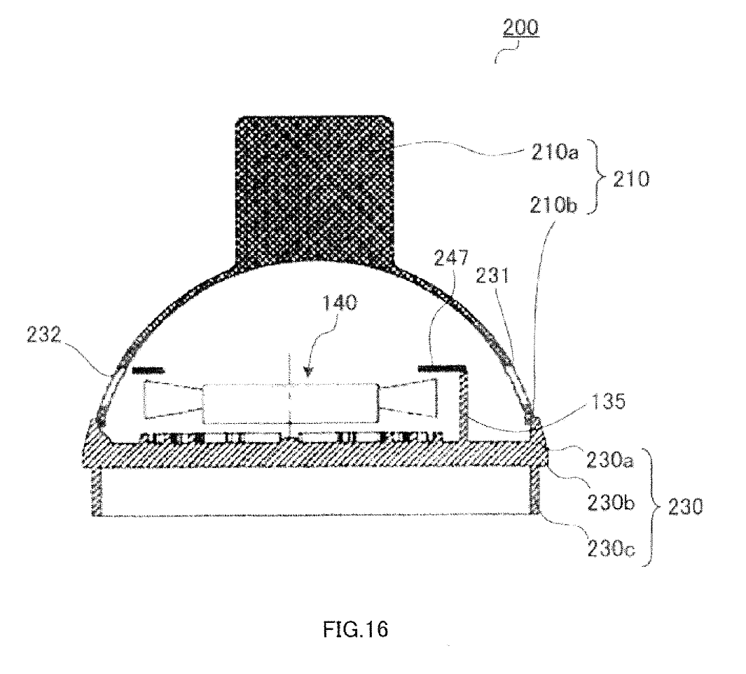

FIG. 15 and FIG. 16 are outside views of an illumination apparatus according to Embodiment 2 of the present invention. FIG. 15 is a top view thereof and FIG. 16 is a cross-sectional view thereof. Components identical to those in FIG. 2 are assigned the same reference numerals and overlapping descriptions will be omitted. For convenience of description, LED substrate 120, power supply substrate 150, connector 123, and irradiation section 160 are omitted. Furthermore, fan apparatus 140 is illustrated in a simplified manner.

The present embodiment is an example where the present invention is applied to a lateral air intake/exhaust LED lamp in which air intake/exhaust directions are located on the lateral side.

As shown in FIG. 15 and FIG. 16, LED lamp 200 is provided with case 210 including base 210a and opening 210b, heat sink 230 that cools the heat of LEDs and fan apparatus 140 that blows air over heat sink 230.

Case 210 is formed in a hemispheric shape with its diameter gradually increasing from rectangular parallelepiped base 210a which is one end side toward opening 210b on the other end side. Case 210 includes screw retainers 210c on the inner wall thereof.

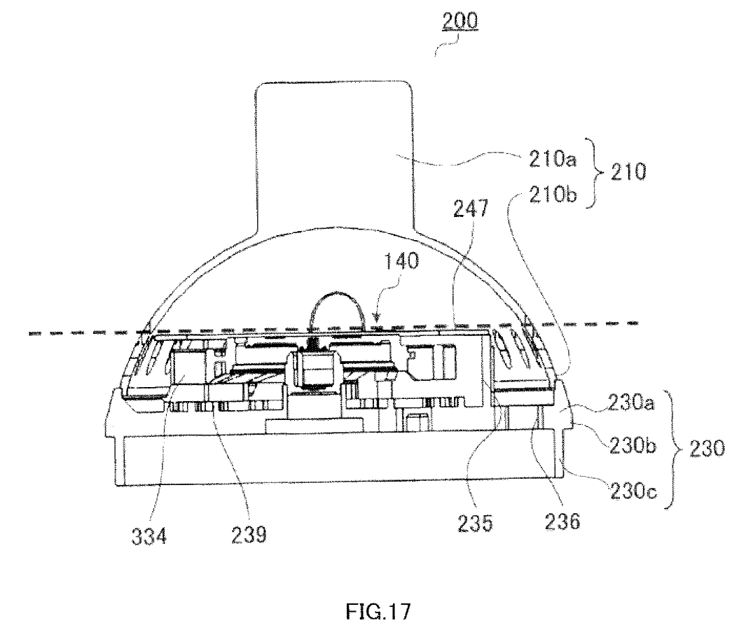

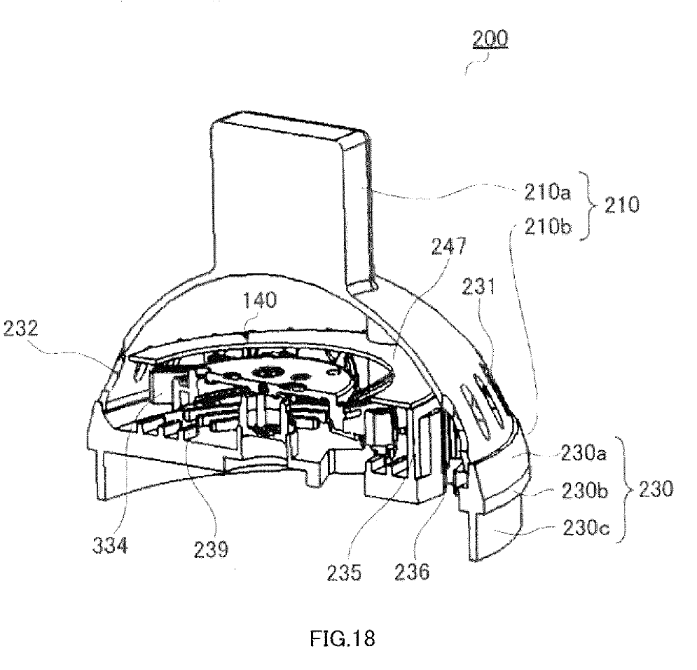

Case 210 is provided with intake ports 231 that take air into fan apparatus 140 and exhaust ports 232 that exhaust air blown over heat sink 230 on the same plane. Intake ports 231 and exhaust ports 232 are formed on both right and left sides of case 210. At least part of exhaust port 232 is formed so as to be located below the top end of fan apparatus 140 on which plate cover 247 is placed. Details of case 210 will be described later using FIG. 17 and FIG. 18.

Heat sink 230 includes outer circumferential part 230a having the same diameter as that of opening 210b of case 210, flange section 230b that protrudes outward from outer circumferential part 230a and cylindrical section 230c that accommodates circular LED substrate 120 (not shown).

Heat sink 230 is attached to opening 210b of case 210 in the same diameter as that of outer circumferential part 230a. Fan apparatus 140 is arranged at a position deviated from the center of heat sink 230 (decentered position).

Both heat sink 230 and fan apparatus 140 have a circular shape in a top view and heat sink 230 has a larger diameter. Since fan apparatus 140 is mounted within the outer diameter of heat sink 230, a circular space is formed on the circumference of fan apparatus 140. Intake ports 231 are formed on the one semi-circle side in case 210 and exhaust ports 232 are formed on the other semi-circle side in case 210. Since intake ports 231 and exhaust ports 232 are formed on both sides of fan apparatus 140 mounted on heat sink 230, that is, on both semi-circle sides of heat sink 230, both ports are aligned on the same plane.

FIG. 17 and FIG. 18 are diagrams illustrating a detailed configuration of LED lamp 200. FIG. 17 is a cross-sectional view thereof and FIG. 18 is a perspective view thereof.

As shown in FIG. 17 and FIG. 18, fan apparatus 140 is arranged at a position deviated from the center of heat sink 230 (decentered position), and the inside of case 210 on the semi-circle side with a wider space is assigned to intake ports 231 and the inside of case 210 on the semi-circle side with a narrower space is assigned to exhaust ports 232.

Heat sink 230 includes partition plate 235 that changes the flow of the air taken into a space between intake ports 231 and fan apparatus 140 and causes the air to flow into fan apparatus 140. Partition plate 235 serves as a screen that covers the intake port 231 side of fan apparatus 140 in a substantially semi-circular shape along the shape of fan apparatus 140. The air taken in by fan apparatus 140 is blown over partition plate 235, and with its flow changed, flown into the intake ports inside plate cover 247 above fan apparatus 140.

Plate cover 247 is attached above partition plate 235 to cover the top outer circumference of fan apparatus 140 and improve the air-blowing efficiency. Plate cover 247 serves as an intake port to fan apparatus 140 and also regulates the air flow.

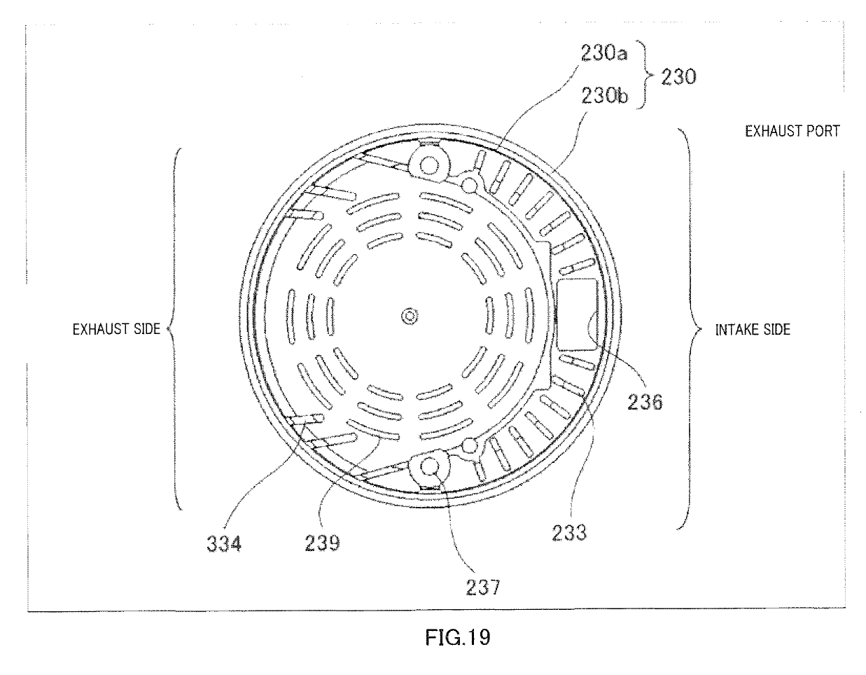

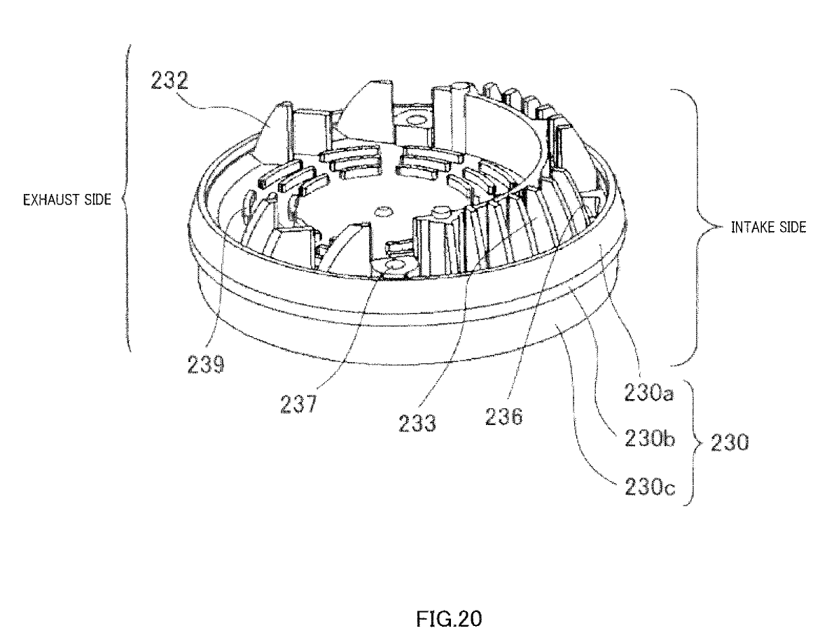

FIG. 19 and FIG. 20 are diagrams illustrating a detailed configuration of heat sink 230. FIG. 19 is a top view thereof and FIG. 20 is a perspective view thereof.

As shown in FIG. 19 and FIG. 20, many heat dissipation fins 233 are formed in heat sink 230 on the intake port 231 side and fewer heat dissipation fins 334 are formed in heat sink 230 on the exhaust port 232 side.

Heat sink 230 has hole 236 to pass connector 123 (not shown) therethrough opened in the undersurface below partition plate 235 on the intake port 231 side. In heat sink 230, threaded holes 237 are formed in the undersurface and air adjusting protrusions 239 are concentrically formed on the mounting surface of fan apparatus 140.

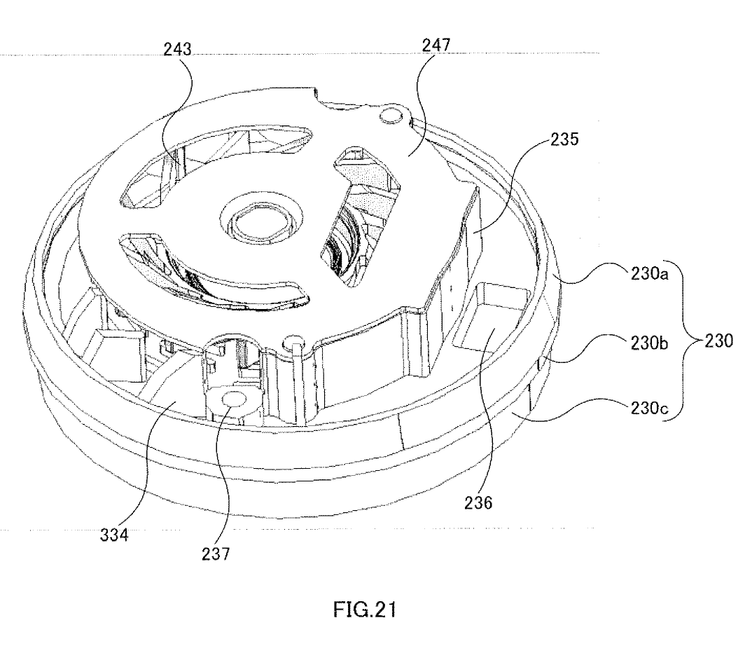

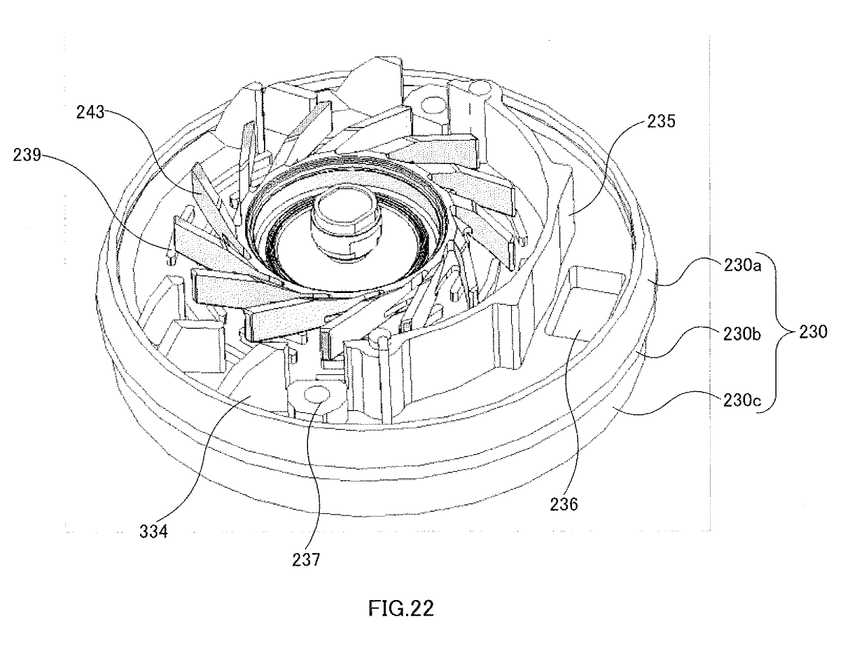

FIG. 21 and FIG. 22 are diagrams illustrating a detailed configuration of heat sink 230. FIG. 21 is a perspective view thereof and FIG. 22 is a perspective view with the plate cover removed from FIG. 21. For convenience of description, heat dissipation fins 333 of intake ports 231 are omitted.

As shown in FIG. 21 and FIG. 22, both heat sink 230 and fan apparatus 140 have a circular shape in a top view and heat sink 230 has a larger diameter. Fan apparatus 140 is arranged at a position deviated from the center (decentered position) of heat sink 230, and the inside of case 210 on the semi-circle side with a wider space is assigned to intake ports 231 and the inside of case 210 on the semi-circle side with a narrower space is assigned to exhaust ports 232.

Heat sink 230 includes partition plate 235 between intake port 231 and fan apparatus 140 to change the flow of air flown into fan apparatus 140. The air taken in by fan apparatus 140 is blown over partition plate 235, and with the flow changed, flown into the intake ports inside plate cover 247 above fan apparatus 140.

In the configuration in FIG. 21 and FIG. 22, partition plate 235 formed in heat sink 230 can support plate cover 247 and plate cover 247 can support fan blade 143. This configuration has an advantage that fan apparatus 140 can be assembled easily. Furthermore, since heat is not directly transmitted to shaft 141 of fan apparatus 140, the motor is less likely to deteriorate and the service life thereof can be extended.

The fan of fan blade 143 of fan apparatus 140 may be oriented upside down.

Hereinafter, operation of the illumination apparatus configured as described above will be described.

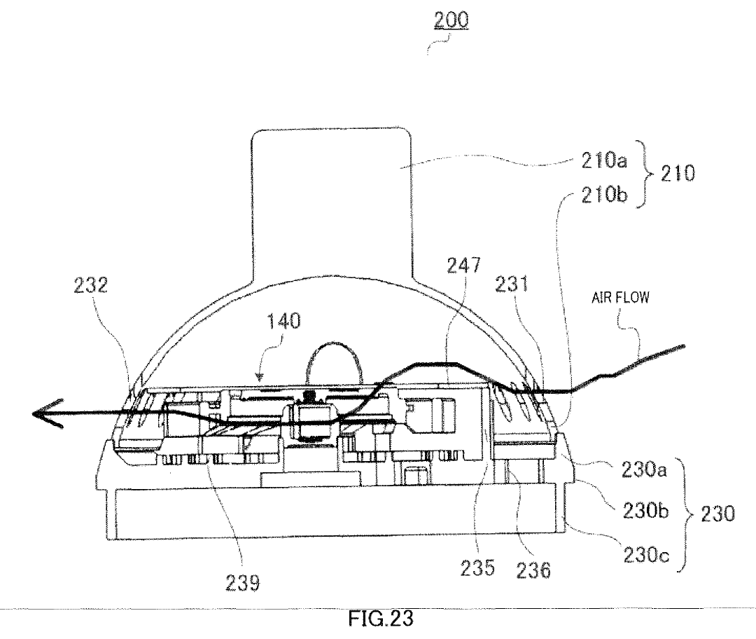

FIG. 23 is a cross-sectional view illustrating an air flow of the illumination apparatus according to the embodiment of the present invention. The solid line arrow in FIG. 23 indicates an air flow.

As shown in FIG. 23, when fan apparatus 140 operates, air is taken in from intake ports 231 formed on one side of case 210, blown over partition plate 135 and reaches an area above fan apparatus 140. The air is then sucked into fan apparatus 140 from plate cover 247 and exhausted from exhaust ports 232 formed on one side of case 210.

Thus, the present embodiment separates intake air from exhaust air in the right-left direction (not in the up-down direction), and can thereby always take in cool air and use it for cooling. That is, intake ports 231 and exhaust ports 232 are arranged at the positions structurally most distant from each other, namely the side positions at both the right and left ends of case 210, and it is thereby possible to always take in cool air and use it for cooling and significantly improve the heat dissipation effect of the fan.

Furthermore, it is possible to form large openings of intake ports 231 and exhaust ports 232 and further improve the air-blowing efficiency.

Furthermore, the air in case 210 basically flows in the right-left direction and there is no forced directional change. Since the air direction is moderately changed, resistance to the air is small and the air-blowing efficiency can be improved.

In the present embodiment, partition plate 235 is formed in heat sink 230. Since partition plate 135 is part of heat sink 230, good heat conductivity is provided and the heat dissipation effect can be improved.

Furthermore, in the present embodiment, partition plate 235 is formed on the intake port 231 side. Since there is no object that blocks the air flow in the vicinity of exhaust ports 232, the air intake/exhaust efficiency can be improved. Furthermore, fan apparatus 140 has a high degree of freedom in arrangement.

Furthermore, the present embodiment forms larger (higher) fins 233 on the intake port 231 side than fins 234 on the exhaust port 232 side. This is attributable to the following reasons. Since the exhaust port 232 side has a higher air velocity than that of the intake port 231 side, the fins on the exhaust port 132 side block the air flow, which is likely to cause the air velocity to decrease. By contrast, intake ports 231 on the intake port 131 side as a whole take in air uniformly and the fins are therefore less likely to block the air flow, making it possible to form large fins. Forming large or many fins can increase the heat dissipation effect of heat sink 130.

In the present embodiment, as shown by the broken line in FIG. 17, at least exhaust ports 232 are formed at a height equal to or lower than that of fan apparatus 140. Intake ports 231 are preferably formed above fan apparatus 140, but may also be otherwise.

To prevent the air from flowing backward from the exhaust side to the intake side, partition plate 235 is preferably extended beyond the top end of fan apparatus 140. The sizes of exhaust ports 232 and intake ports 231 may be about the same. The greater the sizes of exhaust ports 232 and intake ports 231, the better.

It is not impossible to arrange fan apparatus 140 on the intake port 231 side, but there is the following demerit.

The air has a strong centrifugal force, and it is therefore difficult to take in the air from the sides of the fins. Therefore, as in the case of the present embodiment, air is blown over the partition once, and with the direction thereof turned, taken in from above fan apparatus 140 and pushed ahead toward the air exhaust side.

In the present embodiment, fan apparatus 140 may also be configured as a box fan type as in the case of Embodiment 1. Since an annular partition plate surrounds the entire circumference of fan apparatus 140, the box fan type has a high rectification effect and provides an effect of high air-blowing efficiency of the fan.

The description above is an illustration of a preferred embodiment of the present invention and the scope of the present invention is not limited to this.

The terms “fan apparatus” and “illumination apparatus” have been used in the above embodiment, but these terms are used for convenience of description, and the term may be “fan apparatus or the like.”

Furthermore, components making up the above fan apparatus and illumination apparatus, for example, the type of the case and substrate are not limited to the aforementioned embodiment.

### Embodiment 3

Components identical to those in Embodiment 1 and Embodiment 2 are assigned the same reference numerals and overlapping descriptions will be omitted. The present embodiment will describe a case where a centrifugal fan apparatus is used as the fan apparatus. Adopting a centrifugal fan as the fan apparatus can make it easier to blow air in the diameter direction of the fan and optimization of the fin shape of the centrifugal fan blade allows warm air to be effectively exhausted, making it possible to further improve the heat dissipation effect of the fan apparatus.

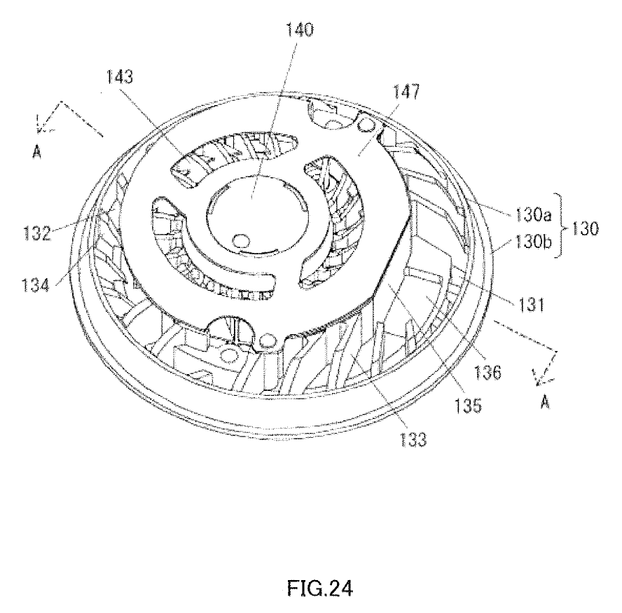

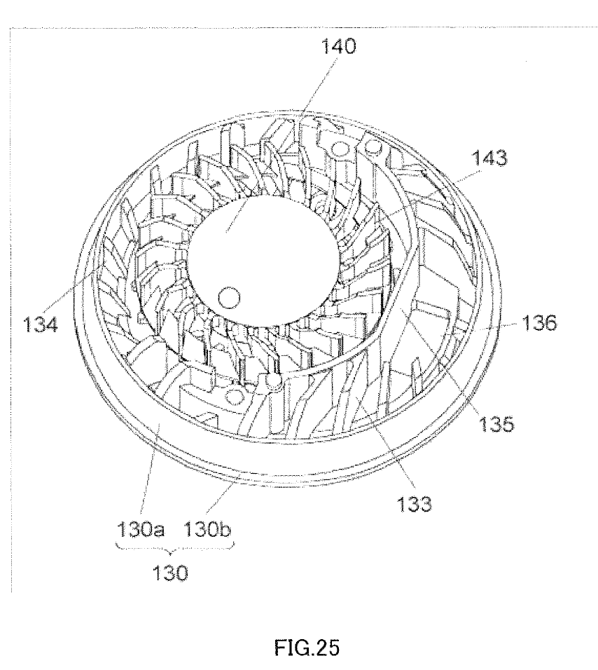

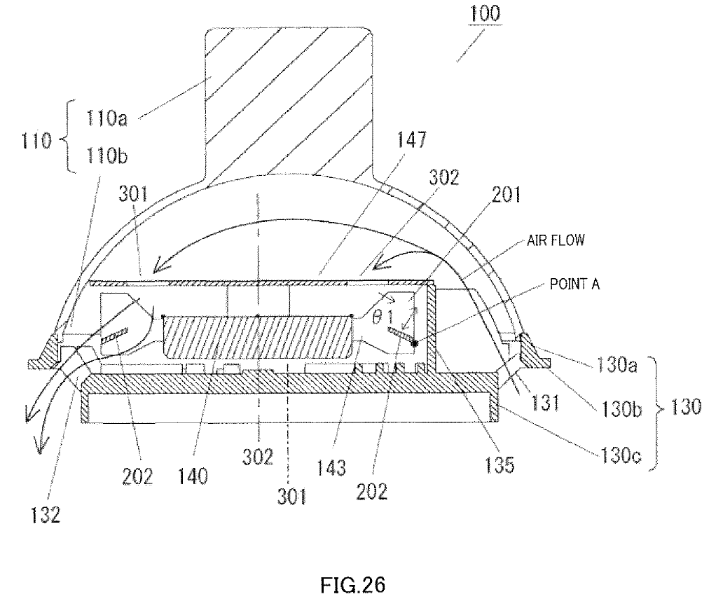

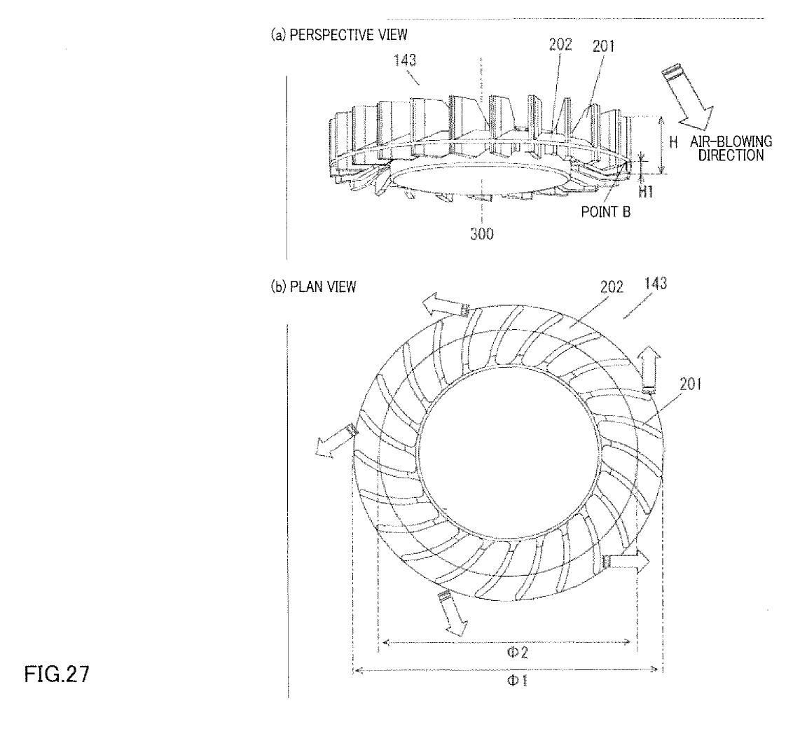

FIG. 24 is a perspective view illustrating a detailed configuration of a heat sink of an illumination apparatus according to Embodiment 3 of the present invention and FIG. 25 is a perspective view illustrating a detailed configuration of the heat sink of the illumination apparatus according to Embodiment 3 of the present invention, showing the heat sink in FIG. 24 with plate cover 147 removed. FIG. 26 is a cross-sectional view of a fan apparatus of the illumination apparatus according to Embodiment 3 of the present invention and FIG. 27 is a configuration diagram of a fan blade of the fan apparatus of the illumination apparatus according to Embodiment 3 of the present invention.

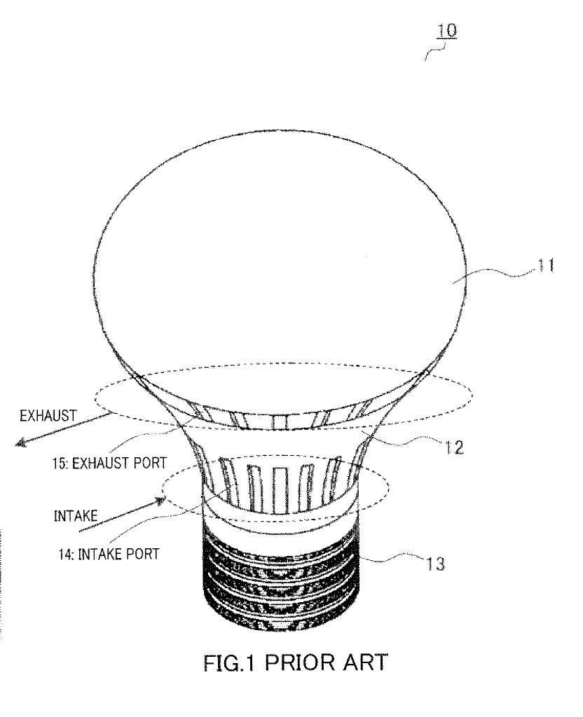

In the present embodiment, fan apparatus 140 uses a centrifugal fan that blows air so as to push air forward in the rotating direction (centrifugal direction) of fan blade 143. That is, in FIG. 26, air is sucked from above the center of fan apparatus 140 and the air is blown out in the right-left direction in the figure by a centrifugal force generated by the rotation of fan blade 143. Compared to an axial fan that blows air in the direction of the axis of rotation of the fan (corresponding to the up-down direction in FIG. 26), a centrifugal fan can more easily blow air in the rotating direction of the fan (corresponding to the right-left direction in FIG. 26). Unlike the prior art in FIG. 1 that takes in and exhausts air in the up-down direction, the invention of the present application takes in and exhausts air in the right-left direction. Therefore, the mounting of the centrifugal fan apparatus makes it possible to improve the cooling effect.

In the case where there is strong resistance in an air channel in which the fan is set up because of miniaturization of the fan apparatus, adopting the centrifugal fan allows the air blowing force to be increased.

Furthermore, as also schematically shown in FIG. 26, a configuration may also be adopted in which bearing 142 is attached to plate cover 147 to be suspended downward and shaft 141 of fan apparatus 140 is supported by bearing 142 (motor 146 in FIG. 10 is turned upside down and supported by plate cover 147 above).

Adopting such a configuration makes it possible to create a space between fan apparatus 140 and heat sink 130, improve the air flow for cooling heat sink 130 and increase the area of contact between heat sink 130 and cooling air. Furthermore, it is possible to prevent heat generated in motor 146 of fan apparatus 140 from directly transmitting to heat sink 130 and thereby prevent the temperature of heat sink 130 from rising.

As shown in FIG. 26, fan apparatus 140 of the present embodiment adopts a configuration of a centrifugal fan and is provided with fan blade 143 that takes in outside air to cool heat sink 130. Auxiliary fin 202 is attached to the outer circumferential part of fan blade 143 which is inclined at a certain angle with respect to the plane perpendicular to axis of rotation 300 of fan apparatus 140.

Next, the shape of fan blade 143 will be described in detail using FIG. 27. Fan blade 143 is made up of many vertical fins 201 attached in the same direction as that of axis of rotation 300 of fan apparatus 140 and auxiliary fins 202 attached to the plane perpendicular to axis of rotation 300 of fan apparatus 140 which is inclined at an angle with respect to the vertical plane.

As shown in FIG. 27(b), the blade of vertical fin 201 is created so as to have a cross section of a moderate curvature to make it easier to push out the intake air. Height H of the outer circumferential part of vertical fin 201 is approximately 6.1 mm.

On the other hand, auxiliary fin 202 is made up of an inclined ring-shaped plane on the outer circumferential part of fan apparatus 140 as shown in FIG. 27. The outer diameter of auxiliary fin 202 (which is also the outer diameter of fan blade 143) φ1 is 30 mm, and inner diameter φ2 of auxiliary fin 202 is 25 mmφ. The inclination of auxiliary fin 202 (θ1 in FIG. 9) may be set to within 30° to 75° but when the angle of inclination is small, this prevents the centrifugal fan of fan apparatus 140 from pushing out air, and on the other hand when the angle of inclination is too large, this reduces a smooth diagonal air flow (direction combining the diameter direction of the centrifugal fan and the axial direction of the fan apparatus; air flow shown by the solid line arrow in FIG. 26). This angle is 63° in the present embodiment. Furthermore, position A of auxiliary fin 202 (see FIG. 26 and FIG. 27; intersection between auxiliary fin 202 and outer circumference of vertical fin 201) may be set to within a range of 0.2≦H1/H≦0.6 to obtain the air flow and the cooling effect of heat sink 130, and this is approximately 0.3 in the present embodiment.

The air flow of the illumination apparatus in the present embodiment 3 will be described using FIG. 26. The solid line arrow in the figure indicates the air flow.

As shown in FIG. 26, heat sink 130 is mounted with fan apparatus 140 at a position deviated from the center (axis 301) of heat sink 130 (axis 302 at a decentered position), and is provided with intake ports 131 and exhaust ports 132 on the same plane. The semi-circle side with a wider space is assigned to intake ports 131 and the semi-circle side with a narrower space is assigned to exhaust ports 132.

When outer circumferential part 130a of heat sink 130 is attached to opening 110b of case 110, intake ports 131 are arranged on the one semi-circle side of substantially circular case 110 and exhaust ports 132 are arranged on the other semi-circle side. That is, most of intake ports 131 and exhaust ports 132 are arranged on the same plane and on different sides of case 110.

Furthermore, partition plate 135 that separates the intake port 131 side from the exhaust port 132 side is arranged in case 110. The present embodiment forms partition plate 135 between intake ports 131 and fan apparatus 140 on heat sink 130.

Here, the periphery of fan blade 143 needs to be surrounded to regulate the air direction in order to improve the air-blowing efficiency of fan apparatus 140. The placement of partition plate 135 and plate cover 147 improves the air-blowing efficiency.

When a centrifugal fan is used as fan apparatus 140, it is possible to make full use of operation characteristics (air flow) of the centrifugal fan by adopting both undersurface air intake/exhaust (air channel configuration in FIG. 26) and lateral air intake/exhaust (configuration in which intake ports 131 and exhaust ports 132 are located in opening 110b of case 110 in FIG. 26) schemes for the air intake/exhaust directions of fan apparatus 140. On the other hand, when auxiliary fins 202 are provided for fan blade 143, it is possible to make full use of operation characteristics (air flow) of the centrifugal fan provided with auxiliary fins 202 by adopting the undersurface air intake/exhaust scheme.

When fan apparatus 140 operates, air is taken in from intake ports 131 of the undersurface of heat sink 130, blown over partition plate 135 and reaches an area above fan apparatus 140 along the side of partition plate 135. The air then goes beyond plate cover 147, is sucked into fan apparatus 140 and exhausted from exhaust ports 132 in the undersurface of heat sink 130 (as shown by the air flow arrow in FIG. 26).

The wind, that is, air flow will be described more specifically. The air sucked in from the intake port of plate cover 147 is sucked into fan apparatus 140 which is a centrifugal fan. The air sucked in from air suction port 301 located in plate cover 147 flows diagonally downward by the propulsion of vertical fins 201 and the gradient of auxiliary fins 202, is blown over heat sink 130 and smoothly exhausted from exhaust ports 132 while cooling heat sink 130.

On the other hand, the air sucked in from air suction port 302 in plate cover 147 flows diagonally downward by the propulsion of vertical fins 201 and the gradient of auxiliary fins 202, and flown into a space surrounded by partition plate 135 and heat sink 130. As described above, since the air sucked in from air suction port 301 is smoothly exhausted from exhaust ports 132, the air flown into the space surrounded by partition plate 135 and heat sink 130 passes through the space between fan apparatus 140 and heat sink 130 with the aid of the air flow, and is smoothly exhausted from exhaust ports 132 while cooling heat sink 130.

That is, by attaching inclined auxiliary fin 202 to fan blade 143, it is possible to take in air from intake port 131 located on the undersurface and create an effective air flow using fan apparatus 140 which is a centrifugal fan and thereby sufficiently cool heat sink 130. Since the air flow is smooth, the air that has cooled heat sink 130 can be exhausted from exhaust ports 132 located in the undersurface without stagnation.

Thus, the present embodiment separates intake air from exhaust air in the right-left direction (not in the up-down direction), and can thereby always take in cool air and use it for cooling. That is, the prior arts separate intake air from exhaust air in the up-down direction, which results in a disadvantage that the intake ports and the exhaust ports are located close to each other, deteriorating the heat dissipation effect of the fan. By contrast, as shown in FIG. 26, the present embodiment arranges most of intake ports 131 and exhaust ports 132 at both right and left ends on the undersurface of opening 110b of case 110, that is, is the positions structurally most distant from each other, and can thereby always take in cool air and use it for cooling and thereby significantly improve the heat dissipation effect of the fan. Furthermore, using a centrifugal fan apparatus as the air-blowing fan, the present embodiment can effectively generate an air flow in the right-left direction and thereby improve the cooling effect.

### Embodiment 4

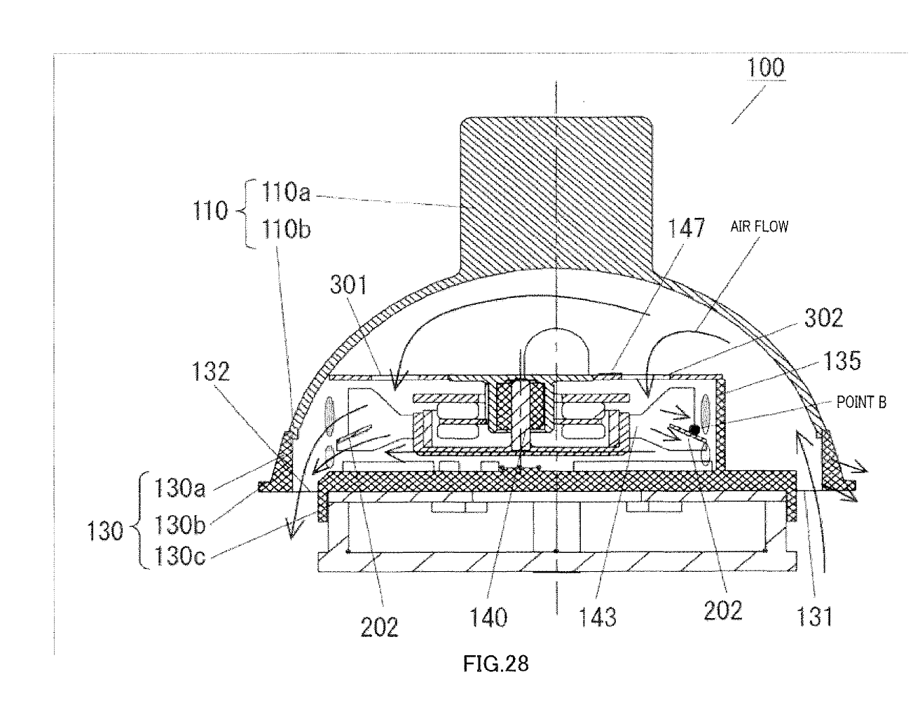

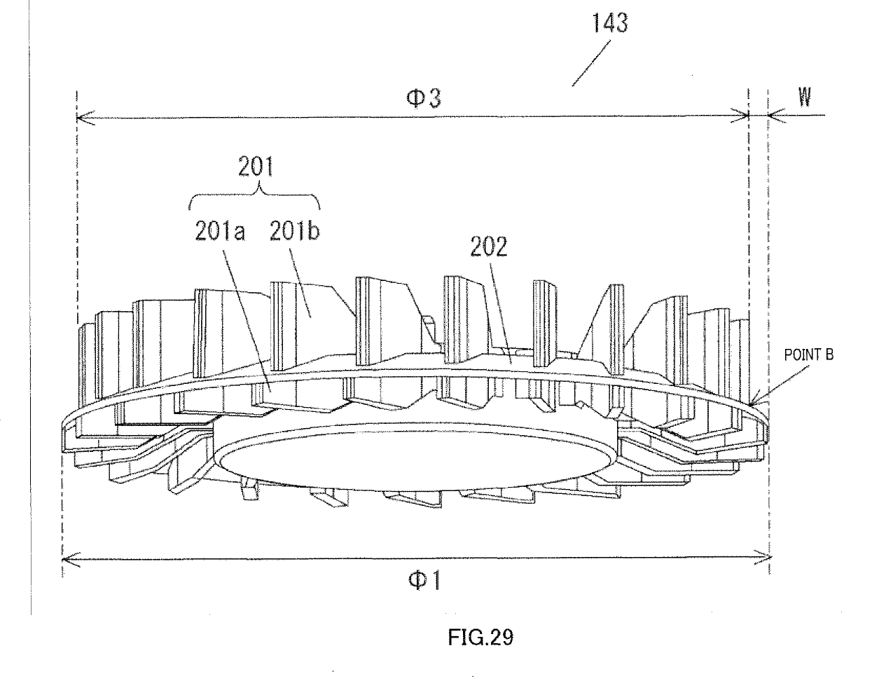

FIG. 28 is a cross-sectional view of a fan apparatus of an illumination apparatus according to Embodiment 4 of the present invention, and FIG. 29 is a configuration diagram of a fan blade of the fan apparatus of the illumination apparatus according to Embodiment 4 of the present invention. Components identical to those in Embodiments 1 to 3 are assigned the same reference numerals and overlapping descriptions will be omitted.

The present embodiment shows an example where a difference in level is provided in the outer circumferential part of vertical fins 201 of fan blade 143, and adopts the same configuration as that of Embodiment 3 for the rest of the configuration.

As shown in FIG. 28, the outer circumferential part of fan blade 143 of fan apparatus 140 has two blade lengths. The length of fan blade 143 differs above and below a point (point B) at which the outer circumferential part of fan blade 143 of fan apparatus 140 intersects inclined auxiliary fin 202.

Fan blade 143 of fan apparatus 140 will be described in detail using FIG. 29. As shown in FIG. 29, vertical fin 201 of fan blade 143 changes the outer diameter at the edge of auxiliary fin 202. That is, vertical fin 201 is made up of two parts; lower blade 201a having a diameter of φ1 and upper blade 201b having a diameter of φ3.

As a result of an intensive study, φ1=31.4 mmφ, φ3=29.2 mmφ and width W of the stepped part is 1.1 mm in the present embodiment. This difference in level may be set to within 0.7 mm to 1.5 mm by combining φ1 and φ3 of vertical fin 201 according to the specification.

As shown in FIG. 28, when fan blade 143 rotates, a vortex of air occurs due to the difference in atmospheric pressure in the vicinity of the outer circumferential part of fan blade 143 (areas indicated by gray ellipsoidal parts). The greater the vortex of air, the louder is the sound produced at fan blade 143. Therefore, if the vortex of air generated can be reduced, the sound at fan blade 143 can be reduced.

In the present embodiment, upper and lower air flowing along auxiliary fin 202 produces a vortex of air in the vicinity of the outer circumference of vertical fin 201 above and below auxiliary fin 202. Here, since the outer diameter of vertical fin 201 differs above and below auxiliary fin 202, the location of the vortex of air generated around the outer circumferential part of vertical fin 201 can be considerably separated or divided (upper and lower areas indicated by the gray ellipsoidal parts). Therefore, since the vortex of air generated can be divided and reduced in size, the generation of sound at fan blade 143 can be suppressed.

As a result of a study, in the case where fan blade 143 has the aforementioned size and the number of revolutions is 5000 rpm, the sound produced without the difference in level was approximately 30 dB and this could be drastically reduced to approximately 27 dB by providing the difference in level.

By making the length of the blade differ above and below a point (point B) at which the outer circumferential part of fan blade 143 of fan apparatus 140 intersects inclined auxiliary fin 202, it is possible to divide the vortex of air generated around the outer circumferential part of fan blade 143 and thereby suppress the sound generated from rotating fan blade 143. Moreover, since the sound generated at fan blade 143 can be suppressed, it is possible to increase the number of revolutions of fan blade 143 and further improve cooling performance of fan apparatus 140.

In FIG. 28, although the length of upper blade 201b of vertical fin 201 is described to be shorter than the length of lower blade 201a of vertical fin 201 at the point (point B) at which auxiliary fin 202 intersects vertical fin 201, the length of lower blade 201a of vertical fin 201 may be shorter than the length of upper blade 201b, in which case effects similar to those described above can be obtained.

### Embodiment 5

Components identical to those in Embodiments 1 to 4 are assigned the same reference numerals and overlapping descriptions will be omitted. The present embodiment will describe the ratio of the area of intake ports and exhaust ports.

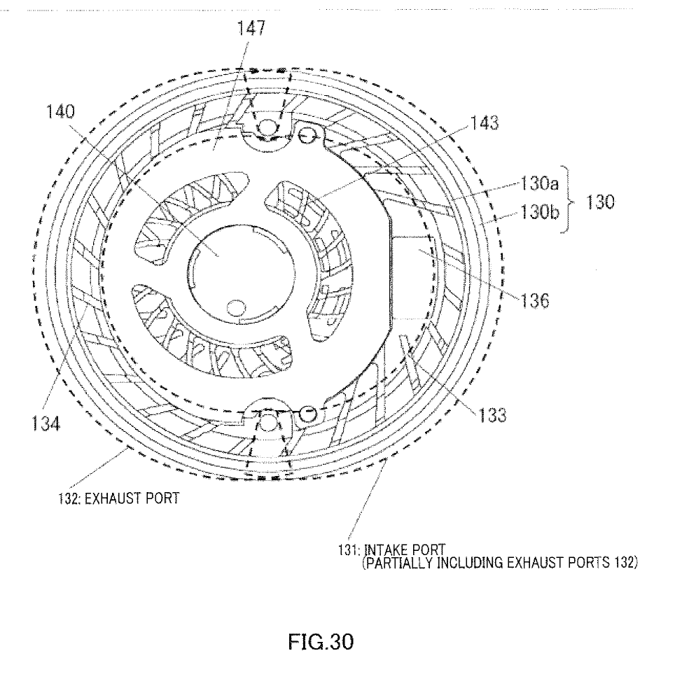

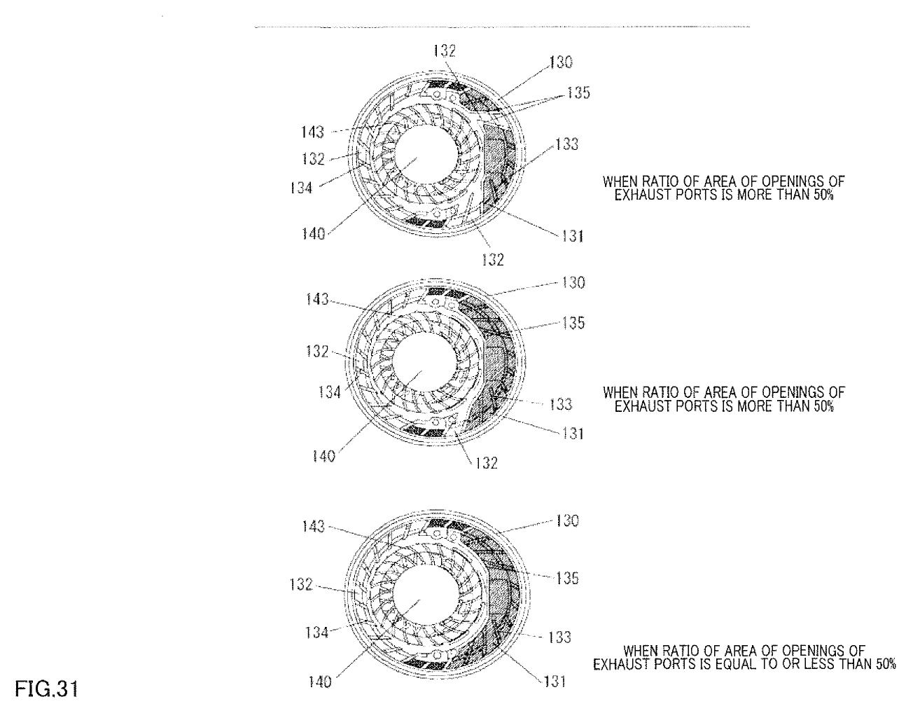

FIG. 30 is a perspective view illustrating a detailed configuration of a heat sink of an illumination apparatus according to Embodiment 5 of the present invention, and FIG. 31 is a bottom view illustrating a detailed configuration of the heat sink of the illumination apparatus according to Embodiment 5 of the present invention.

In FIGS. 30 and 31, the shape of fan blade 143 of fan apparatus 140 is illustrated as a centrifugal type, but it may also be an axial fan (propeller fan) or may be any one of the two.

To confine a temperature rise of heat sink 130 within an operating range, the ratio of the area of openings of exhaust ports 132 to the total area of openings of effectively operating intake ports 131 and exhaust ports 132 is 50 to 70%. This ratio is preferably 55 to 65%. That is, the ratio of the area of openings of intake ports 131 and the area of openings of exhaust ports 132 formed in the undersurface of heat sink 130 is approximately 40:60.

Here, the area of opening refers to the area of through holes of intake ports 131 or exhaust ports 132 provided by penetrating heat sink 130.

Furthermore, there are some intake ports 131 or exhaust ports 132 that do not mainly exert their intake or exhaust functions due to the attachment of plate cover 147 or the like. In this case, the area of openings of these ports will not be included in the area used for calculating the aforementioned ratio of the area of openings.

Furthermore, since intake ports 131 and exhaust ports 132 are formed on both sides of fan apparatus 140 mounted on heat sink 130, that is, on both semi-circle sides of heat sink 130, both ports are aligned on the same plane.

Furthermore, in the present embodiment, fan apparatus 140 is arranged at a position deviated from the center of heat sink 130 (decentered position), and the side with a wider space (right side in FIG. 30) is assigned to intake ports 131 and the side with a narrower space (left side in FIG. 30) is assigned to exhaust ports 132. This makes it possible to provide hole 136 opened to pass connector 123 of wiring from fan apparatus 140 on the side with a wider space (right side in FIG. 30).

Next, intake ports 131 and exhaust ports 132 provided in heat sink 130 will be described in detail using FIG. 31.

In FIG. 31, a cross-hatched area in the present embodiment is a region where air is substantially not taken in or exhausted in order to connect heat sink 130 and plate cover 147, and a hatched area is a region (first space) responsible for air intake and other non-hatched areas are regions (second space, third space) responsible for air exhaust. The opening in which air is taken in or exhausted is formed in part of the region responsible for air intake/exhaust.

Furthermore, the opening such as the cross-hatched area which is not actively involved in air intake/exhaust is not included in the calculation of the aforementioned ratio of the area of opening.

To make the description easy to understand hereinafter, intake/exhaust ports are uniformly distributed on the outer circumference of heat sink 130 and the lengths of openings in the axial direction are also assumed to be the same in the present embodiment. That is, since the areas of openings of the respective intake/exhaust ports are equal, the number of openings of intake/exhaust ports is used as a substitute for the respective areas of openings. However, not only in the aforementioned cases, but also when heat sink 130 is not uniformly distributed or when the lengths of openings in the axial direction are different, the ratio may be eventually calculated as the sum total of areas of openings of intake/exhaust ports.

In the bottom figure of FIG. 31, intake ports 131 and exhaust ports 132 are divided on the right and left on the outer circumference of heat sink 130 and arranged as a plurality of openings as described above. The number of intake ports on the outer circumference of heat sink 130 is 10, the number of exhaust ports is 10 and the ratio of the area occupied by exhaust ports on the outer circumference of heat sink 130 is 50%. At this time, the temperature rise in the vicinity of LED 121 mounted on heat sink 130 was 38.9° C.

That is, even when intake ports 131 and exhaust ports 132 are divided on the right and left on the outer circumference of heat sink 130 and the ratio of the area of openings of intake ports 131 and exhaust ports 132 is 50%, by separating intake air from exhaust air in the right-left direction, it is possible to always take in cool air and use it for cooling without taking in the exhausted warm air again and prevent the temperature rise in the vicinity of LED 121 mounted on heat sink 130.

As a result of an intensive study to further reduce the temperature rise in the vicinity of LED 121 mounted on heat sink 130, an appropriate ratio of the area of openings occupied by intake ports 131 and exhaust ports 132 on the outer circumference of heat sink 130 was found.

The middle figure of FIG. 31 shows a case where one exhaust port 132 (corresponding to the third space) is provided on the intake port 131 side, there are nine intake ports 131 and eleven exhaust ports 132 on the outer circumference of heat sink 130, and the ratio of the area occupied by exhaust ports 132 on the outer circumference of heat sink 130 is approximately 55%. The temperature rise in the vicinity of LED 121 mounted on heat sink 130 at this time was 36.1° C.

That is, intake ports 131 and exhaust ports 132 are divided on the right and left on the outer circumference of heat sink 130 and it is possible to smoothly exhaust the air used for cooling from exhaust ports 132 without the resistance from the outside air taken in from intake port 131 by increasing the ratio of the area of openings of intake ports 131 and exhaust ports 132, and it is thereby possible to prevent the temperature rise in the vicinity of LED 121 mounted on heat sink 130.

However, when the ratio of the area of opening reaches 70% or higher, the sufficient outside air cannot be taken in from intake ports 131, and therefore heat sink 130 cannot be cooled sufficiently.

In the middle figure of FIG. 31, added exhaust port 132 is located in the lower part of the figure, but this position is not exclusive and the same effect can also be obtained when exhaust port 132 is located in the upper part of the intake region in the figure.

Next, the top figure in FIG. 31 shows a case where a plurality of exhaust ports 132 (corresponding to the third space) are provided on the intake port 131 side, and there are seven intake ports 131 and thirteen exhaust ports 132 on the outer circumference of heat sink 130, and the ratio of the area occupied by exhaust ports 132 on the outer circumference of heat sink 130 is approximately 65%. The temperature rise in the vicinity of LED 121 mounted on heat sink 130 at this time was 37.5° C.

That is, by dividing the air intake region where intake ports 131 are located and providing exhaust ports 132 there, it is possible to effectively exhaust the warm air remaining in fan apparatus 140 and suppress the temperature rise in the vicinity of LED 121 mounted on heat sink 130 even when the intake region into which outside air used for cooling is taken in becomes smaller.

Thus, by providing more exhaust ports 132 than intake ports 131 to thereby set the ratio of the area of opening thereof to 55 to 70%, the study result showed that it was possible to suppress the temperature rise in the vicinity of LED 121 mounted on heat sink 130.

Furthermore, by providing added exhaust port 132 in the region of intake port 131 divided in the right-left direction, it is possible to effectively exhaust the warm air remaining in fan apparatus 140 and further increase the heat dissipation effect of fan apparatus 140.

The illumination apparatus and the fan unit for an illumination apparatus of the present invention are suitable for use in a bulb type LED lamp provided with a fan apparatus that cools an LED mounting substrate.

### Embodiment 6

Components identical to those in Embodiments 1 to 5 are assigned the same reference numerals and overlapping descriptions will be omitted. In the present embodiment, the shape of the case is partially changed.

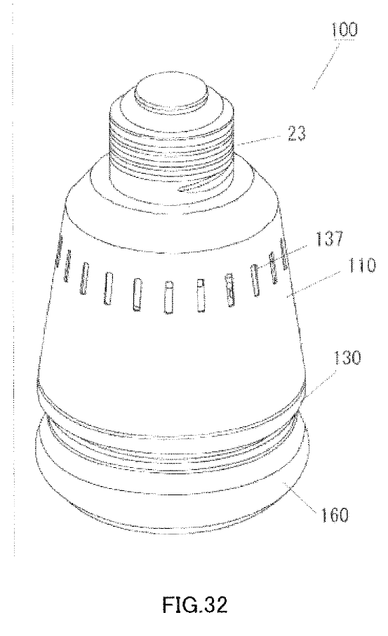

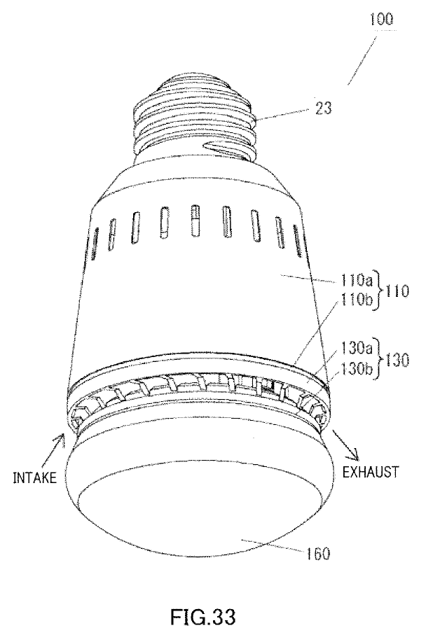

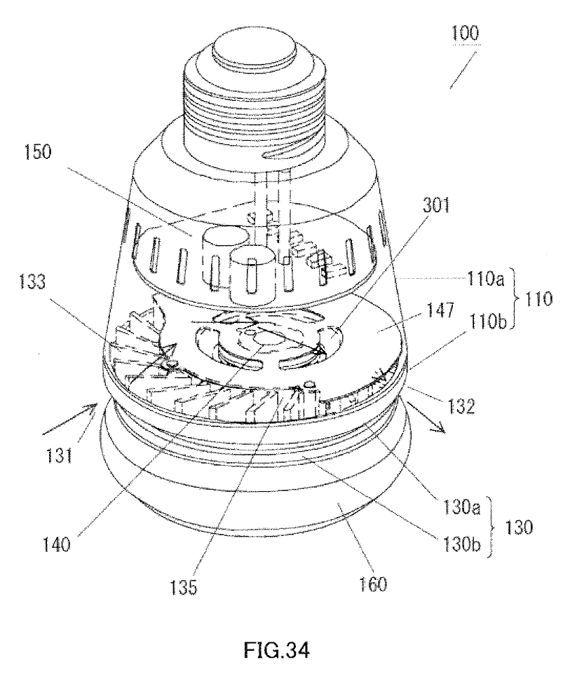

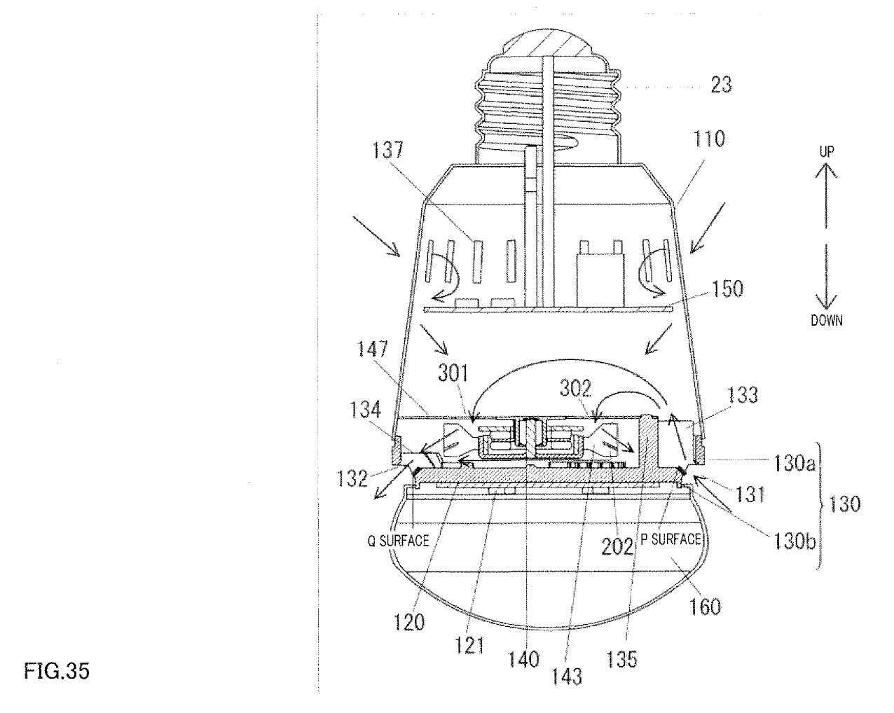

FIG. 32 is a perspective view of an illumination apparatus according to Embodiment 6 of the present invention. FIG. 33 is a perspective view of the illumination apparatus according to Embodiment 6 above. FIG. 34 is a perspective view illustrating an air flow of the illumination apparatus according to Embodiment 6 above. FIG. 35 is a cross-sectional view illustrating an air flow of the illumination apparatus according to Embodiment 6 above.

Case 110 is formed in a hemispheric shape with its diameter gradually increasing from on one end side where base 23 is attached toward opening 110b which is the other end side. That is, since an incandescent electric lamp is accommodated in base 110a of case 110, base 110a is formed of an inclined plane extending downward. Intake ports 137 which are first intake ports to take in outside air are provided in an upper part of the inclined plane of base 110a. Intake ports 137 are preferably arranged at positions closer to the base 23 side (upper side) than the top end of fan apparatus 140 and at least arranged closer to the base 23 side than the bottom end of fan apparatus 140.

Heat sink 130 is mounted with fan apparatus 140 at a position deviated from the center of heat sink 130 (decentered position), and is provided with intake ports 131 and exhaust ports 132 on the same plane. The semi-circle side with a wider space is assigned to intake ports 131 and the semi-circle side with a narrower space is assigned to exhaust ports 132.

Furthermore, a plurality of intake ports 137 that take in outside air are provided above base 110a, that is, on the wall of base 110a above the surface on which power supply substrate 150 is located.

When outer circumferential part 130a of heat sink 130 is attached to opening 110b of case 110, intake ports 131 are arranged on one semi-circle side of substantially circular case 110 and exhaust ports 132 are arranged on the other semi-circle side. That is, intake ports 131 and exhaust ports 132 are arranged on the same plane and on different sides of case 110. Since intake ports 131, fan apparatus 140 and exhaust ports 132 are arranged on substantially the same plane along heat sink 130, intake ports 131 and exhaust ports 132 can be arranged spaced apart from each other without increasing the size of LED lamp 100, and cool intake air can thereby be blown over the heat sink and the cooling effect can thereby be improved.

The ratios of the area of openings occupied by intake ports 131 and exhaust ports 132 on the outer circumference of heat sink 130 along heat sink 130 are substantially the same or the ratio of the area of openings occupied by exhaust ports 132 is greater.

Thus, the present embodiment provides many intake ports 137 on substantially the entire circumference of case 110, and can thereby easily take a large amount of cool outside air into LED lamp 100. As a result, the area of openings of exhaust ports 132 is preferably greater than the area of openings of intake ports 131 and the combined area of openings of intake ports 131 and intake ports 137 is preferably greater than the area of openings of exhaust ports 132.

Inclined surfaces (P surface and Q surface) are formed on part of heat sink 130 at intake ports 131 and exhaust ports 132 provided in heat sink 130 as shown in FIG. 35.

When fan apparatus 140 performs air intake/exhaust, these inclined surfaces form a flow of air taken in from the diagonal lower right (in FIG. 35) in the case of air intake, and a flow of air blown toward the diagonal lower left (in FIG. 35) in the case of air exhaust.

The angle formed by this inclined surface with respect to the direction of the axis of rotation of fan apparatus 140 is substantially 45°, and may be set within a range of 20° to 70° so as not to overlap with the edge of irradiation section 160 that preferably performs irradiation over a wider range.

The surface of outer circumferential part 130a opposed to the P surface and Q surface may also be an inclined surface. An inclined surface may be formed for at least one of the opposed surfaces, but it is more effective to form inclined surfaces on both of the opposed surfaces.

Furthermore, partition plate 135 that separates the intake port 131 side from the exhaust port 132 side is arranged in case 110. The present embodiment forms partition plate 135 between intake port 131 and fan apparatus 140 on heat sink 130. That is, two spaces are formed partitioned by partition plate 135; a space (first space) including intake ports 131 and greater heat dissipation fins 133, and a space (second space) including exhaust ports 132, smaller heat dissipation fins 134, most of cylindrical section 130b of heat sink 130 and fan apparatus 140.

Here, to improve the air-blowing efficiency of fan apparatus 140, it is necessary to surround the periphery of fan blade 143 to regulate the air direction. The air-blowing efficiency is improved by setting up partition plate 135 and plate cover 147.

As shown in FIG. 35, when fan apparatus 140 operates, the outside air is sucked from intake ports 131 diagonally below heat sink 130 along the inclined surface (P surface) of heat sink 130, passes through a space between greater heat dissipation fins 133 of heat sink 130, is blown over partition plate 135 while cooling heat sink 130 and reaches an upper part of fan apparatus 140 along the side of partition plate 135. The air passes through the intake port of plate cover 147′, is sucked from above into fan apparatus 140 and exhausted from exhaust ports 132 diagonally below heat sink 130 along the inclined surface (Q surface) of heat sink 130 (as shown by the arrow indicating the air flow in FIG. 35).

Similarly, when fan apparatus 140 operates, the outside air is also taken in from intake ports 137 provided in case 110, passes through a gap between case 110 and power supply substrate 150 while cooling electrical parts attached to power supply substrate 150 and reaches plate cover 147 above fan apparatus 140. The air passes through the intake port of plate cover 147, is sucked from above into fan apparatus 140 and exhausted diagonally downward from exhaust ports 132 diagonally below heat sink 130 along the inclined surface (Q surface) of heat sink 130 (as shown by the arrow indicating the air flow in FIG. 35).

The wind, that is, a flow of air will be described more specifically. The air sucked from intake port 301 and intake port 302 of plate cover 147 is sucked into fan apparatus 140 which is a centrifugal fan. When the resistance of the air channel in which the fan is set up is strong due to the miniaturization of fan apparatus 140 or the like, adopting a centrifugal fan can increase the air-blowing force. Furthermore, even when an axial fan is mounted on fan apparatus 140, a similar effect can be obtained though not superior to the centrifugal fan.

The air taken in from intake port 301 in plate cover 147 flows diagonally downward through the propulsion of fan blade 143 and the inclination of auxiliary fins 202, is blown over smaller heat dissipation fins 134 of heat sink 130 and smoothly exhausted diagonally downward along the inclined surface (Q surface) of heat sink 130 through exhaust ports 132 while cooling heat sink 130.

On the other hand, the air taken in from intake port 302 in plate cover 147 flows diagonally downward through the propulsion of fan blade 143 and inclination of auxiliary fin 202, and flows into the space surrounded by partition plate 135 and heat sink 130. Since the air taken in from the intake ports is smoothly exhausted from exhaust ports 132 as described above, the air flown into the space surrounded by partition plate 135 and heat sink 130 with the aid of the air flow passes through a space between fan apparatus 140 and heat sink 130, and is smoothly exhausted diagonally downward along the inclined surface (Q surface) of heat sink 130 through exhaust ports 132 while cooling heat sink 130.

That is, by forming inclined surfaces in intake ports 131 and exhaust ports 132, it is possible to take in an air flow generated through the operation of fan apparatus 140 from diagonally downward and exhaust the air flow diagonally downward, thereby to create an effective air flow and sufficiently to cool heat sink 130. Since the air flows smoothly, the air that has cooled heat sink 130 can be exhausted from exhaust ports 132 without stagnation.

Furthermore, as shown in FIG. 35, intake ports 131 are provided close to the outer end of heat sink 130, and after the outside air passes through intake ports 131, the air flows into the wide space inside heat sink 130, and it is thereby possible to guide the flow of the air taken in from intake ports 131 diagonally upward.

Furthermore, exhaust ports 132 are arranged at positions below the bottom end of fan blade 143 of fan apparatus 140 and outside the outer diameter of fan blade 143. This allows the flow of the air exhausted from exhaust ports 132 to be guided diagonally downward.

Thus, the present embodiment separates intake air from exhaust air in the right-left direction (not in the up-down direction), and can thereby always take in cool air and use it for cooling. That is, the prior arts separate intake air from exhaust air in the up-down direction, and therefore have a disadvantage that intake ports and exhaust ports are located close to each other and the heat dissipation effect of the fan deteriorates. By contrast, as shown in FIG. 35, the present embodiment arranges intake ports 131 and exhaust ports 132 at both right and left end positions of opening 110b of case 110, namely the positions structurally most distant from each other, and can thereby always take in cool air and use it for cooling, and significantly improve the heat dissipation effect of fan apparatus 140.

Furthermore, since the intake direction is set to the diagonally upward direction and the exhaust direction is set to the diagonally downward direction, it is possible to prevent once exhausted warm air from being immediately reused for intake.

Furthermore, since intake ports 137 are provided in an upper part of base 110a of case 110, it is also possible to cool power supply substrate 150 attached to the upper part of case 110, further take in outside cool air for cooling while avoiding retaking the air exhausted diagonally downward from exhaust ports 132 and effectively use the air flow, and thereby improve the heat dissipation effect of fan apparatus 140 which is the cooling section.

Furthermore, since intake/exhaust ports are provided in diagonally downward directions, dust or the like floating in the air is unlikely to be taken into case 110 and it is possible to prevent the air-blowing resistance in the air channel and maintain the cooling performance of fan apparatus 140. That is, when intake ports 131 are formed in the upward direction or diagonally upward direction or lateral direction, floating dust is more likely to be actively taken in from above. To prevent this, the present embodiment assumes the intake direction to be the diagonally downward direction. Furthermore, since heat sink 130 is located in the downward direction seen from fan apparatus 140, it is necessary to blow air in the downward direction to efficiently blow the air of fan apparatus 140 over heat sink 130. That is, since the exhaust direction is the downward direction, the air blown over the heat sink 130 side can be exhausted with less resistance of the air channel. On the contrary, determining the exhaust direction to be the upward direction results in greater resistance of the air channel and considerably reduces the air-blowing efficiency.

Furthermore, since the air intake/exhaust direction is set to the diagonally downward direction, it is possible to increase the size in the lateral direction of irradiation section 160 and thereby radiate light from irradiation section 160 over a wide range. That is, if the air intake/exhaust direction is set to the directly downward direction, nothing can be provided right below intake ports 131 and exhaust ports 132 to secure the intake/exhaust air channel. On the other hand, the greater the size of irradiation section 160, the wider is the range over which light from irradiation section 160 can be radiated. Furthermore, to radiate light of LED 121, LED 121 and irradiation section 160 are necessarily arranged below heat sink 130. That is, LED 121 and irradiation section 160 are necessarily arranged below intake ports 131 and exhaust ports 132. For the above reasons, if the air intake/exhaust direction is set to the directly downward direction, the area of irradiation section 160 for securing the air channel is considerably reduced. As a result, this light radiating range is limited. However, the present embodiment determines the air intake/exhaust direction to be the diagonally downward direction, and can thereby arrange irradiation section 160 in part of the area right below intake ports 131 and exhaust ports 132. Furthermore, since the air flow from intake port 131 to exhaust port 132 is not the up-down direction but the right-left direction, setting the air intake/exhaust direction not to the downward direction but to the diagonally downward direction makes it possible to suppress the overall resistance of the air channel and smoothly perform air intake/exhaust.

Furthermore, there are the following differences between the present embodiment and prior arts in the shapes of regions in which intake and exhaust ports are formed respectively.

In the prior arts, the width of the fan in the axial direction is small and the fan has an annular shape (laterally elongated shape in a plan view) and the resistance of passing air is strong. On the other hand, in the present embodiment, intake port 131 and exhaust port 132 have a semi-circular shape and more similar to a square than the prior arts in a plan view. For this reason, the resistance of passing air becomes weaker, making it possible to improve the air-blowing efficiency.

Furthermore, in the prior arts, if an attempt is made to increase the distance between intake ports and exhaust ports, it is necessary to reduce the size of openings of the intake ports and exhaust ports to relatively increase the distance. The present embodiment has no such structural limitations, can increase the size of openings of intake ports 131 and exhaust ports 132 and thereby further improve the air-blowing efficiency.

Furthermore, as shown in FIG. 8, the air in case 110 basically flows in the right-left direction and there is no forced directional change. Since the air directional change is moderate, the resistance to the air is weak and the air-blowing efficiency can be improved.

### INDUSTRIAL APPLICABILITY

The illumination apparatus of the present invention is suitable for use in a bulb type LED lamp provided with a fan apparatus that cools an LED mounting substrate.

1. An illumination apparatus comprising:
an LED;
a heat sink that dissipates heat of the LED;
a case having an opening on the heat sink side;
intake ports formed in some parts on an outer circumference side of the heat sink or the case;
exhaust ports that exhaust air blown over the heat sink, the exhaust ports being formed in some other parts on the outer circumference side of the heat sink or the case where the intake ports are not formed;
a fan apparatus that blows the air taken in via the intake ports to the heat sink side, the fan apparatus being provided between the heat sink and the case; and
a partition plate that separates a first space including the intake ports from a second space including the exhaust ports.

2. The illumination apparatus according to claim 1, wherein the intake ports and the exhaust ports are formed on the case side.

3. The illumination apparatus according to claim 1, wherein the intake ports and the exhaust ports are formed in the undersurface of the outer circumferential part of the heat sink.

4. The illumination apparatus according to claim 1, wherein the intake ports, the fan apparatus and the exhaust ports are arranged on a substantially identical plane along the heat sink.

5. The illumination apparatus according to claim 1, wherein a center of the fan apparatus is deviated from a center of the case toward the exhaust port side.

6. The illumination apparatus according to claim 1, wherein the partition plate surrounds the entire outer circumference of the fan apparatus.

7. The illumination apparatus according to claim 1, wherein the partition plate separates the intake ports from the fan apparatus.

8. The illumination apparatus according to claim 1, wherein the exhaust ports overlap with the fan apparatus in an up-down direction.

9. The illumination apparatus according to claim 1, wherein the fan apparatus is a centrifugal fan apparatus.

10. The illumination apparatus according to claim 9, wherein a ring inclined along the direction of the exhaust ports from the center of the axis is provided on the entire circumference of the fan blade of the centrifugal fan apparatus.

11. The illumination apparatus according to claim 1, wherein an area of openings of the exhaust ports is greater than an area of openings of the intake ports.

12. The illumination apparatus according to claim 11, further comprising a third space created by dividing the first space to exhaust air blown over the heat sink.

13. The illumination apparatus according to claim 11, wherein an area of openings of the exhaust ports is 50 to 70% of a combined area of openings of the intake ports and the exhaust ports.

14. A fan unit for an illumination apparatus comprising:
a heat sink that dissipates heat of an LED;
intake ports formed at some parts on an outer circumference side of the heat sink;
exhaust ports that exhaust air blown over the heat sink, the exhaust ports being formed at some other parts on the outer circumference side of the heat sink where the intake ports are not formed;
a fan apparatus that blows the air taken in via the intake ports to the heat sink side, the fan apparatus being provided on the heat sink; and
a partition plate that separates a first space including the intake ports from a second space including the exhaust ports.

15. The fan unit for an illumination apparatus according to claim 14, wherein the intake ports and the exhaust ports are formed in the undersurface of the outer circumferential part of the heat sink.

16. The fan unit for an illumination apparatus according to claim 14, wherein the intake ports, the fan apparatus and the exhaust ports are arranged on a substantially identical plane along the heat sink.

17. The fan unit for an illumination apparatus according to claim 14, wherein a center of the fan apparatus is deviated from a center of the case toward the exhaust port side.

18. The fan unit for an illumination apparatus according to claim 14, wherein the partition plate separates the intake ports from the fan apparatus.

19. The fan unit for an illumination apparatus according to claim 14, wherein the fan apparatus is a centrifugal fan apparatus.

20. The fan unit for an illumination apparatus according to claim 14, wherein an area of openings of the exhaust ports is greater than an area of openings of the intake ports.
